(19) United States
(12) Patent Application Publication
(10) Pub. No.: US 2026/0260637 A1
(43) Pub. Date: Sep. 3, 2026

(54) SECURE REMOTE VIRTUAL SOUND ENGINEER SYSTEM WITH LOCAL COMMAND EXECUTION AND CLOUD-BASED SESSION MANAGEMENT

(71) Applicant: 302609 LLC, Wilmington, DE (US)

(72) Inventors: Wallace Levi Coleman, Wilmington, DE (US); Charles Homer, Lawrenceville, GA (US)

(21) Appl. No.: 19/381,119

(22) Filed: Nov. 6, 2025

Related U.S. Application Data
(63) Continuation-in-part of application No. 18/082,925, filed on Dec. 16, 2022, now Pat. No. 12,656,997.
Application No. 18/082,925 is a continuation-in-part of application No. 17/217,906, filed on Mar. 30, 2021, now Pat. No. 11,561,758.
(60) Provisional application No. 63/064,095, filed on Aug. 11, 2020.

(51) Int. Cl. G10H 1/00; G06T 17/10

(52) U.S. Cl. CPC G10H 1/0058; G06T 17/10

(57) ABSTRACT

A system for remote control of a physical mixing board can include a cloud server to establish a remote connection between a remote engineer device and a host device to remotely control the physical mixing board. The cloud server can: in response to receipt of a first request, from the host device, to host a digital mixing session for the sound session, initiate the digital mixing session, receive a request to remotely access the digital mixing session from the remote engineer device, which can include session information associated with the digital mixing session, grant, based on validating the session information, remote access to the digital mixing session, receive, from the remote engineer device, signals for controlling the physical mixing board, format and wrap the signals into a signal packet, and direct the signal packet to the host device for execution to automatically adjust the physical mixing board.

### CROSS-REFERENCE TO RELATED APPLICATIONS

This application is a continuation-in-part of U.S. Application Serial No. 18/082,925, entitled “VIRTUAL SOUND ENGINEER SYSTEM AND METHOD,” which was filed on December 16, 2022, which is a continuation-in-part of U.S. Application Serial No. 17/217,906, entitled “VIRTUAL SOUND ENGINEER SYSTEM AND METHOD,” which was filed on March 30, 2021, and which claimed priority to Provisional Patent Application having serial number 63/064,095, filed August 11, 2020, the disclosures of each of which are hereby incorporated by reference in their entireties.

### TECHNICAL FIELD

The present disclosure generally relates to remote sound engineering management, and in particular, to remotely controlling a physical mixing board with secure, remote digital mixing sessions.

### BACKGROUND

A physical mixing board (e.g., audio mixer) is a hardware device that can be used to combine, adjust, and route multiple audio signals for a sound session. The physical mixing board can provide tactile controls such as faders, knobs, and buttons for managing input levels, equalization, dynamics, and output routing. Because these controls are mechanical, an operator must be physically present at an event location to make adjustments during a live performance, recording session, or other location having sound.

A digital sound mixer may be configured to convert received analog audio signals to a digital form prior to processing the audio signal. Example digital sound mixer may include one or more peripheral equipment input terminals and may be configured to perform microphone signal preamplification, channel equalization, and dynamic range compression. The digital sound mixer can communicate with or sometimes be integrated with the physical mixing board to cause adjustments to the physical mixing board during the sound session.

### SUMMARY

The disclosed technology is generally directed to remote audio mixing for live events and other sound sessions. The disclosed technology can provide for bridging physical mixing boards at various physical locations with cloud-based control interfaces. More specifically, the disclosed technology can provide a host relay architecture that can be configured to connect a local physical mixing board (e.g., digital mixer) to a secure cloud service, thereby allowing professional sound engineers to operate the physical mixing board from any location. A venue-side relay application can establish a direct open sound control (OSC) link to the physical mixing board for low-latency execution of commands, while the cloud layer can manage session authentication, routing, and/or multi-user coordination. The disclosed technology therefore ensures that real-time adjustments can be executed locally for speed, while state synchronization and session management may occur over encrypted channels.

As an illustrative example of the disclosed technology, a user physically located at the sound session can create a session and approve remote access with a unique session key. Once authorized and connected to the session, a remote engineer can interact with a browser-based dashboard or other application to generate and send control commands, which can be securely routed through the cloud architecture to the host relay and then automatically executed on the physical mixing board. The disclosed technology can support bidirectional state updates, so that any change on the physical mixing board and/or remote interface can be instantly reflected across devices of all participants (e.g., the host and the remote engineer(s)). The disclosed technology therefore provides real-time synchronization, multi-engineer support, conflict resolution, and latency optimization for local command execution. By combining local command execution with cloud-based coordination, the disclosed technology delivers improved remote mixing capabilities without compromising reliability or performance, which are critical for live or other real-time sound sessions.

One or more embodiments described herein can include a virtual sound engineer system for remote control of a physical mixing board during a sound session, the system including: a cloud server that can be configured to establish a remote connection between a remote engineer device and a host device to remotely control the physical mixing board, the cloud server being configured to perform operations that can include: in response to receipt of a first request, from the host device, to host a digital mixing session for the sound session, initiating the digital mixing session, receiving a second request to remotely access the digital mixing session from the remote engineer device, the second request including session information associated with the digital mixing session, granting, based on validating the session information, remote access of the remote engineer device to the digital mixing session, where in response to granting the remote access, the remote engineer device can be configured to present the digital mixing session in a virtual sound engineer dashboard, receiving, from the remote engineer device and based on the remote access to the digital mixing session, one or more signals for controlling the physical mixing board, formatting and wrapping the one or more signals for controlling the physical mixing board into a signal packet, and directing the signal packet to the host device for execution, where the host device can be configured to automatically adjust the physical mixing board based on the one or more signals in the signal packet.

The system can optionally include one or more of the following features. For example, the operations can further include receiving, from the host device, updated values that were generated at the physical mixing board in response to the host device automatically adjusting the physical mixing board, and transmitting the updated values to the remote engineer device for real-time presentation in the virtual sound engineering dashboard. The remote engineer device can be further configured to receive user input indicating one or more additional controls based on the updated values that are presented in the virtual sound engineering dashboard at the remote engineer device. The operations further can include: processing the updated values to validate that the updated values correspond to the one or more signals for controlling the physical mixing board that were received from the remote engineer device. Sometimes, the operations can also include receiving (i) audio data by channels from audio sources and (ii) visual data by channels from cameras, the channels from the audio sources and the channels from the cameras being separate and distinct channels of communication. As another example, the operations can also include transmitting the audio data and the visual data to the remote engineer device for presentation in the virtual sound engineering dashboard, and receiving, from the remote engineer device, other signals for controlling the physical mixing board based on the audio data and the visual data that are presented in the virtual sound engineering dashboard.

In some implementations, the host device and the remote engineer device can be configured to present the same virtual sound engineering dashboard. State changes that can be detected at the physical mixing board can be transmitted, by the cloud server, to the host device and the remote engineer device to cause the virtual sound engineering dashboard to be updated and synchronized in real-time. The virtual sound engineering dashboard can be presented based on rendering a three-dimensional (3D) representation of the physical mixing board at the host device and the remote engineer device. The 3D representation of the physical mixing board can include a group of virtual user controls that can correspond to physical controls on the physical mixing board. At least one of the remote engineer device or the host device can be configured to: receive user input indicating a change in position of a virtual user control associated with at least one of the physical controls on the physical mixing board, and transmit the user input to the cloud server for formatting and directing to the physical mixing board for automatic execution. The physical mixing board can be at a physical location of the sound session. The host device can be at a physical location of the sound session and the remote engineer device can be remote from the physical location of the sound session. The remote engineer device can be at another physical location that can be different than the physical location of the sound session.

One or more embodiments described herein can include a virtual sound engineer system for remote control of a physical mixing board during a live sound session at a physical location, the system including: a cloud server that can be configured to provide a digital connection between a remote engineer device, a host device, and the physical mixing board. The cloud server can be configured to perform operations that can include: receiving, from the remote engineer device and by a remote access digital mixing session, one or more signals for controlling the physical mixing board, wrapping the one or more signals for controlling the physical mixing board, and directing the wrapped signals to the host device by the remote access digital mixing session. The host device can be configured to automatically execute the wrapped signals to control the physical mixing board in real-time.

The system can optionally include one or more of the abovementioned features and/or one or more of the following features. For example, the operations can also include (i) initiating a first access digital mixing session between the cloud server and the host device and (ii) directing the wrapped signals to the host device by the first access digital mixing session. The operations can include (i) initiating a second access digital mixing session between the cloud server and the remote engineer device and (ii) receiving the one or more signals for controlling the physical mixing board from the remote engineer device by the second access digital mixing session. Sometimes, the operations can include: receiving, from the host device, updated values that were generated at the physical mixing board in response to the automatic execution of the wrapped signals, and transmitting the updated values to the remote engineer device for real-time presentation in a virtual sound engineering dashboard. The operations can also include: receiving, from the physical mixing board, (i) audio data that was generated by audio sources and (ii) visual data that was generated by cameras, transmitting the audio data and the visual data to the remote engineer device for real-time presentation in a virtual sound engineering dashboard, and receiving, from the remote engineer device, additional signal commands for controlling the physical mixing board based on the audio data and the visual data that can be presented in the virtual sound engineering dashboard. Sometimes, the host device and the remote engineer device can be configured to present a same virtual sound engineering dashboard. As another example, the physical mixing board can be configured to generate updated state change information in response to the host device automatically executing the wrapped signals to control the physical mixing board. The operations further can include: receiving the updated state change information from the physical mixing board, and broadcasting the updated state change information to the host device and the remote engineer device for real-time presentation in one or more graphical user interfaces (GUIs).

In one or more embodiments, a virtual sound engineer system includes a mobile device including a processor connected to an interface, the processor being configured to: in response to receiving a first access code, initiate a first remote access digital mixing session to remotely access a first digital mixing console, wherein the first digital mixing console is communicatively coupled to a first plurality of peripheral devices disposed at a first location, in response to receiving a second access code, initiate a second remote access digital mixing session to remotely access a second digital mixing console, wherein the second digital mixing console is communicatively coupled to a second plurality of peripheral devices disposed at a second location different from the first, wherein remotely accessing the first digital mixing console and the second digital mixing console includes adjusting sound output by at least one of the peripheral devices of the first digital mixing console and at least one of the peripheral devices of the second digital mixing console, and wherein at least a portion of the first remote access digital mixing session and at least a portion of the second remote access digital mixing session occur concurrently. In some implementations, the first access code can be used to start the session to remotely access the first digital mixing console and the second access code can be used to initiate remote access to the second digital mixing console at a same or different location. This can allow for the virtual sound engineer system to remotely control multiple sessions, such as first and second sessions.

A method includes, in response to receiving a first access code, by a processor, initiating a first remote access digital mixing session to remotely access a first digital mixing console, wherein the first digital mixing console is communicatively coupled to a first plurality of peripheral devices disposed at a first location, in response to receiving a second access code, initiating a second remote access digital mixing session to remotely access a second digital mixing console, wherein the second digital mixing console is communicatively coupled to a second plurality of peripheral devices disposed at a second location different from the first, wherein remotely accessing the first digital mixing console and the second digital mixing console includes adjusting sound output by at least one of the peripheral devices of the first digital mixing console and at least one of the peripheral devices of the second digital mixing console, and wherein at least a portion of the first remote access digital mixing session and at least a portion of the second remote access digital mixing session occur concurrently.

A virtual sound engineer system includes a mobile device including a processor and an interface connected to the processor. The processor is configured to generate a first unique identifier for a first remote access digital mixing session and generating first access credentials associated with the first unique identifier, generate a second unique identifier for a second remote access digital mixing session and generate second access credentials associated with the second unique identifier, transmit the first access credentials to a first user device disposed at a first location and transmit the second access credentials to a second user device disposed at a second location different from the first, initiate the first remote access digital mixing session to remotely access a first digital mixing console stored on the first user device, wherein the first digital mixing console is communicatively coupled to a first plurality of peripheral devices disposed at the first location, initiate the second remote access digital mixing session to remotely access a second digital mixing console stored on the second user device, wherein the second digital mixing console is communicatively coupled to a second plurality of peripheral devices disposed at the second location, wherein remotely accessing the first digital mixing console and the second digital mixing console includes adjusting sound output by at least one of the peripheral devices of the first digital mixing console and at least one of the peripheral devices of the second digital mixing console, and wherein at least a portion of the first remote access digital mixing session and at least a portion of the second remote access digital mixing session occur concurrently.

A virtual sound engineer system includes a mobile device coupled to a head-mounted display. The mobile device is configured to: in response to receipt of a first access code including authorization information, initiate a first remote access digital mixing session by generating a virtual sound engineering dashboard to remotely access a first digital mixing console disposed at a first location, and wherein the first digital mixing console is communicatively coupled to a first plurality of peripheral devices disposed at the first location; receive real-time audio and video data captured by at least one of the peripheral devices of the first digital mixing console at the first location in response to initiating the first remote access digital mixing session; display, with the head-mounted display at a second location different from the first location, the virtual sound engineering dashboard in a virtual reality interface based on the real-time audio and video data; and control the first digital mixing console with the virtual sound engineering dashboard in the virtual reality interface.

A method for a virtual sound engineer system includes, in response to receiving a first access code including authorization information, by a mobile device, initiating a first remote access digital mixing session by generating a virtual sound engineering dashboard to remotely access a first digital mixing console disposed at a first location, and wherein the first digital mixing console is communicatively coupled to a first plurality of peripheral devices disposed at the first location; receiving, by the mobile device, real-time audio and video data captured by at least one of the peripheral devices of the first digital mixing console at the first location in response to initiating the first remote access digital mixing session; displaying, by the mobile device, with a head-mounted display at a second location different from the first location, the virtual sound engineering dashboard in a virtual reality interface based on the real-time audio and video data; and controlling, by the mobile device, the first digital mixing console with the virtual sound engineering dashboard in the virtual reality interface.

The disclosed technology can provide one or more of the following advantages. For example, the disclosed technology addresses technical problems with traditional remote control systems that risk unauthorized access, session hijacking, and cross-interference between multiple venues or sound session locations. The technical solution provided by the disclosed technology includes use of unique session keys with expiration metrics, venue-side approval of remote access, and session isolation combined with encrypted data transport. These mechanisms can enforce strict authentication and prevent cross-session contamination, something that cannot be reliably achieved by manual processes or mental reasoning because it requires cryptographic operations, secure key generation, and real-time validation across distributed systems.

The disclosed technology also addresses network reliability issues with existing remote control systems. Live audio control can be highly sensitive to latency and network interruptions, which the existing systems struggle to deal with. The disclosed technology, on the other hand, provides a technical solution in its hybrid network architecture where OSC commands can remain on local area networks for sub-50ms execution, while a cloud layer/architecture of the disclosed technology handles session coordination operations. Features such as automatic reconnection and graceful degradation can be performed by the disclosed technology to ensure continuity without human intervention, which are tasks that involve protocol-level retries, state caching, and delta synchronization. Additionally, the human mind lacks the capabilities to handle such complex, data-driven operations in real-time.

As another example, the disclosed technology addresses performance and bandwidth constraints inherent in existing systems. Real-time mixing can require ultra-low latency and efficient data transfer. Sending full-state snapshots can further expend necessary bandwidth and compute resources, thereby introducing lag to the existing control systems. The disclosed technology, on the other hand, provides a technical solution to these constraints by implementing local OSC execution timestamp-based performance tracking, and delta updates to transmit only changed parameters. The optimizations introduced by the disclosed technology can require complex algorithmic computation and state-diffing logic, which are inherently machine-executed processes, not operations that can be performed within the human mind. Similarly, the disclosed technology involves cryptographic key generation, real-time encrypted communication, network-level failover logic, protocol wrapping, and state synchronization across distributed clients. These operations all require computational precision, concurrency handling, and millisecond-level timing, which cannot be executed mentally in the human mind or with pen-and-paper. The disclosed technology’s technical effect can be achieved through specialized software, network protocols, and hardware integration, not abstract ideas.

The disclosed technology further provides one or more practical applications in remote control of sound systems. For example, the disclosed technology provides for remote live event mixing, allowing sound engineers to manage multiple venues and/or sound sessions without traveling, thereby reducing cost and enabling rapid deployment and scalability. The disclosed technology also provides for disaster recovery and redundancy. If an on-site engineer is unavailable, for example, a remote engineer can take over instantly, in real-time. The disclosed technology can provide multi-engineer collaboration as another practical application. Multiple authenticated engineers can work on a same session in real-time, with conflict resolution techniques handled programmatically and automatically. Moreover, the disclosed technology provides another practical application in scalable production. As a result, centralized teams can manage many venues simultaneously, which is impossible with physical workflows and existing remote control systems. One or more other practical applications and technical advantages may be realized from the disclosure herein.

### BRIEF DESCRIPTION OF THE DRAWINGS

The detailed description particularly refers to the following figures, in which:

FIG. 1 is a block diagram illustrating an example sound engineering system;

FIGS. 2A-2B are block diagrams illustrating example interface layouts of the sound engineering system of FIG. 1;

FIG. 3 is a block diagram illustrating an example virtual sound engineer device;

FIG. 4 is a block diagram illustrating an example environment generated by virtual sound engineer device of FIG. 3;

FIG. 5 is a block diagram illustrating an exemplary process flow for remotely accessing and controlling multiple digital mixing consoles;

FIG. 6 is a block diagram illustrating an exemplary process flow for permitting remote access and control of a digital mixing console;

FIG. 7 is a block diagram illustrating an exemplary process flow for generating access credentials for remotely accessing multiple digital mixing consoles; and

FIG. 8 is a block diagram illustrating another exemplary sound engineering system.

FIGS. 9A, 9B, and 9C illustrate an example process for establishing, maintaining, and ending a remote session connection to control a physical mixing board.

FIG. 10 is a conceptual diagram of a system for sending commands remotely to a physical mixing board.

FIG. 11 is a conceptual diagram of the system of FIG. 10 illustrating example channels of communication.

FIG. 12 is a flowchart of a process for directing controls and other signals to a physical mixing board.

FIGS. 13-21 depict exemplary arrangements of virtual sound engineer (VSE) dashboard pages.

### DETAILED DESCRIPTION

While the concepts of the present disclosure are susceptible to various modifications and alternative forms, specific exemplary embodiments are been shown by way of example in the drawings and will be described. It should be understood, however, that there is no intent to limit the concepts of the present disclosure to the particular forms disclosed; on the contrary, the intention is to cover all modifications, equivalents, and alternatives falling within the spirit and scope of the invention as defined by the appended claims.

References in the specification to “one embodiment,” “an embodiment,” “an illustrative embodiment,” etc., indicate that the described embodiment may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); (A and C); or (A, B, and C). Similarly, items listed in the form of “at least one of A, B, or C” can mean (A); (B); (C): (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

An example virtual sound engineering system of the present disclosure is configured to manage, concurrently, sound output by each of a plurality of digital mixing consoles located at different geographic locations. A virtual sound engineering application includes a dashboard interface configured to receive user (e.g., sound engineer) input to control one or more devices connected to a digital mixing console that is located at a remote site. A virtual sound engineering application is configured to receive, from a mobile device at the remote site, an access code (e.g., an access identifier) that authorizes the virtual sound engineering application to generate a virtual sound engineering dashboard including one or more controls for peripheral devices connected to the digital mixing console at the remote site. The mobile device at the remote site may be configured to, in response to a corresponding request, issue, to the virtual sound engineering application, the access code for controlling one or more peripheral devices connected. In some instances, the mobile device may issue the access code, to the virtual sound engineering application, for controlling fewer than all peripheral devices connected thereto (e.g., partial control, such as for live video reception).

The virtual sound engineering application may be configured to receive a video feed from the mobile device located at the remote site, where the video feed includes video data captured in real time at the remote site. In one example, a camera of the mobile device at the remote site may be oriented toward event guests, performers, or the audience, such that the video feed window of the virtual sound engineering application is indicative of a reaction or behavior of the guests or the audience to changes in sound balance at the remote site, where the changes in sound balance are effectuated using the virtual sound engineering application.

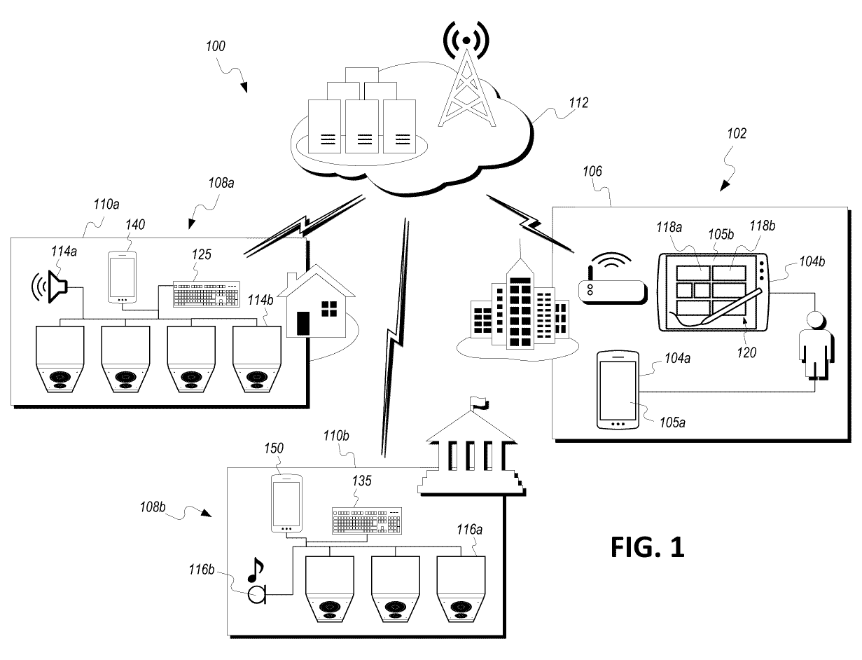

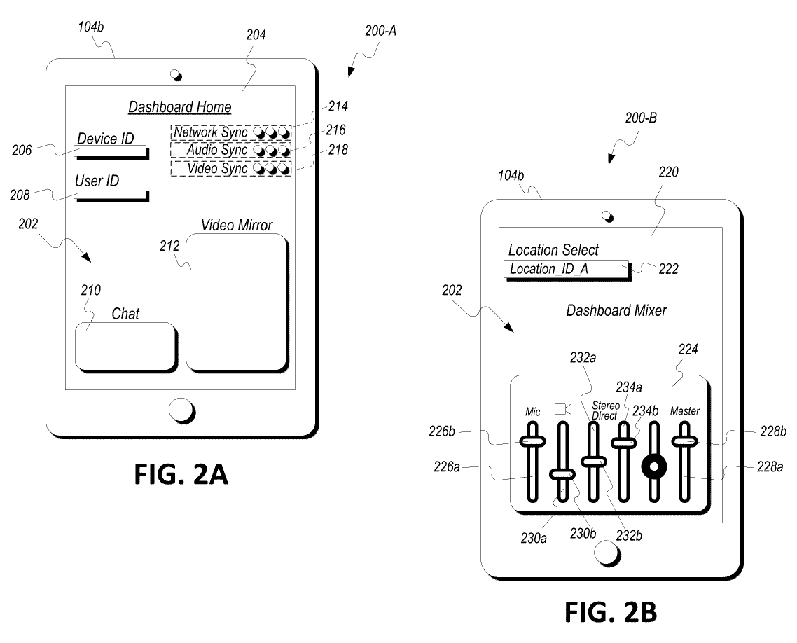

FIG. 1 illustrates an example system 100 for monitoring and controlling, from a remote location, sound input and output by peripheral devices located at different geographic locations from one another and from the remote location. The system 100 includes a virtual sound engineer system 102 accessible using one or more virtual sound engineer user devices 104 (e.g., virtual sound engineer devices 104a, 104b). As described in reference to at least FIGS. 2A-2B, the virtual sound engineer device 104 includes a virtual sound engineer access application 120 downloadable from a digital marketplace (e.g., an app store) of the virtual sound engineer devices 104.

Interface of the virtual sound engineer access application 120 is accessible via one or more mobile or stationary virtual sound engineer devices 104 (e.g., virtual sound engineer devices 104a, 104b), such as, but not limited to, a computer, a smart phone, a tablet computer, a laptop computer, a notebook computer, a mobile computing device, a desktop computer, a work station, a cellular telephone, a handset, a messaging device, a vehicle telematics device, a network appliance, a web appliance, a distributed computing system, a multiprocessor system, a consumer electronic device, a digital television device, and/or any other computing device.

Example virtual sound engineer device 104 includes one or more audio and visual output devices, such as, but not limited to, speakers and displays, and one or more audio and visual input devices, such as, but not limited to, microphones and cameras. Example virtual sound engineer device 104 may receive user input using one or more user input interfaces 105, such as, but not limited to, touch screens, touch pads, digital and/or physical buttons, keys, and keyboards. Additionally or alternatively, the virtual sound engineer device 104 may be configured to perform speech, face, and hand gesture recognition and/or receive user input by way of voice commands, stylus inputs, single- or multi-touch gestures, and touchless hand gestures.

The virtual sound engineer system 102 is disposed at a remote location 106. A first digital mixing site 108a is located at a first location 110a and a second digital mixing site 108b is located at a second location 110b, where each of the first location 110a and the second location 110b are different from one another and from the remote location 106. Each of the first digital mixing site 108a and the second digital mixing site 108b include corresponding user devices 140, 150. The user device 140 of the first digital mixing site 108a is communicatively coupled to a first digital mixing console 125 of the mixing site 108a, wherein the first digital mixing console 125 is communicatively coupled to at least one peripheral device 114. The user device 150 of the second digital mixing site 108b is communicatively connected to a second digital mixing console 135 of the mixing site 108b, wherein the second digital mixing console 135 is communicatively coupled to one or more peripheral devices 116 of the mixing site 108b.

In one example, different locations 106, 110a, and 110b may include one or more of different municipalities, townships, counties, cities, countries, and continents. In another example, the locations 106, 110a, and 110b include one or more different rooms or floors within a single building, adjacent buildings, buildings or locations disposed within a line of sight from one another, and buildings or locations within a predefined distance of one another (e.g., within a radius of 0.5 miles, 5 miles, or one hundred miles). In still another example, one or more of the locations 106, 110a, and 110b may be a location partially or entirely outside an enclosure or structure, such as an enclosed or open-air stage or dance floor in a multi-stage or a multi-dance floor event, such as, but not limited to, a concert, a fair, a festival, or another celebration or a religious or secular commemoration.

Moreover, while the locations 110a and 110b are separated from one another by a predefined distance, digital mixing sessions taking place at each of the different locations 110a and 110b may overlap in time, either in whole or in part. Put another way, at least a portion of the digital mixing sessions at each of the locations 110a and 110b may occur at a same time, concurrently, contemporaneously, or simultaneously. Further, duration of the overlap the digital mixing session at the locations 110a and 110b may, but need not, be several seconds, minutes, hours, days, or any other amount of time.

The virtual sound engineer system 102 is communicatively coupled, via a network 112, to each of the first digital mixing site 108a and the second digital mixing site 108b. The network 112 may be embodied as any type of network capable of communicatively connecting the virtual sound engineer system 102 to each of the first digital mixing site 108a and the second digital mixing site 108b, such as a cloud network, an Ethernet-based network, etc. Accordingly, the network 112 may be established through a series of links/interconnects, switches, routers, and other network devices which are capable of connecting the virtual sound engineer system 102 to each of the first digital mixing site 108a and the second digital mixing site 108b of the network 112. As will be described in further detail below (see, e.g., FIGS. 2A-2B), the virtual sound engineer system 102 and each of the first digital mixing site 108a and the second digital mixing site 108b form a comprehensive data processing, analysis, and exchange system.

The virtual sound engineer system 102 is configured to monitor and control sound output by one or more peripheral input and output devices 114, 116 communicatively coupled to the first digital mixing console 125 of the first digital mixing site 108a and the second digital mixing console 135 of the second digital mixing site 108b, respectively. In an example, the virtual sound engineering system 102 is configured to generate, e.g., during a first digital mixing session, a first digital mixing console 118a including one or more controls for controlling input and output of the peripheral devices 114 of the first digital mixing site 108a. In another example, the virtual sound engineering system 102 is configured to generate, e.g., during a second digital mixing session, a second digital mixing console 118b including one or more controls for controlling input and output of the peripheral devices 116 of the second digital mixing site 108b.

Each of the first digital mixing console 118a and the second digital mixing console 118b may comprise digital renderings, reproductions, or representations, whether exact or approximate, of the first digital mixing console 125 and the second digital mixing console 135, respectively. Additionally or alternatively, one or both of the first digital mixing console 118a and the second digital mixing console 118b may comprise digital representations indicative of remote access (by the virtual engineer device 104) of the user device 140 connected to the first digital mixing console 125 and the user device 150 connected to the second digital mixing console 135, respectively. In some instances, the first digital mixing console 118a, as rendered on the interface 105, may include either same or different number (whether more or fewer) of controls as the first digital mixing console 125 and the second digital mixing console 118b, as rendered on the interface 105, may include either same or different number (whether more or fewer) of controls as the second digital mixing console 135. As just one example, one or more controls of the first digital mixing console 118a, as rendered on the interface 105, may be arranged differently from corresponding controls of the first digital mixing console 125 and/or controls of the second digital mixing console 118b, as rendered on the interface 105, may be arranged differently from corresponding controls of the second digital mixing console 135.

The virtual sound engineer system 102 is configured to receive, via the first digital mixing console 118a, user input indicating a request to balance the sound input and output by microphones, speakers, and instruments connected to the first digital mixing console 125 of the first digital mixing site 108a. The virtual sound engineer system 102 is configured to receive, via the second digital mixing console 118b, user input indicating a request to balance the sound input and output by microphones, speakers, and instruments connected to the second digital mixing console 135 of the second digital mixing site 108b.

FIG. 2A illustrates an example layout 200-A of a first digital interface 204 of the virtual sound engineer access application 202 accessible from the virtual sound engineer device 104 (e.g., the virtual sound engineer device 104b). The first digital interface 204 may be used to initiate a connection (e.g., via the network 112) with each of the digital mixing consoles 125, 135 of the first digital mixing site 108a and the second digital mixing site 108b to enable monitoring and controlling operation of the peripheral devices 114, 116 connected thereto.

One or more operations may precede or follow the establishing of the connection between the virtual sound engineer device 104 and one of the digital mixing consoles 125, 135. In an example, prior to initiating a connection, the virtual sound engineer access application 202 may be configured to request user input indicative of a user profile setup, such as, but not limited to, name or stage name of the sound engineer, music genre in which the sound engineer specializes, sound engineer experience level, and professional accomplishments. Additionally or alternatively, the virtual sound engineer access application 202 may be configured to generate a user profile using personal details associated with an existing identity profile of a social media or another platform, e.g., via a user-authorized single sign-on operation.

The first digital interface 204 includes a device identifier input field 206 and a user identifier input field 208. The virtual sound engineer access application 202 may request user input for one or both of the device identifier input field 206 and the user identifier input field 208 prior to proceeding with initiating the connection between the virtual sound engineer device 104 and one of the digital mixing consoles 125, 135. In one example, a user identifier of the virtual sound engineer using the virtual sound engineer access application 202 is a string of numeric, alpha-numeric, or alphabetical characters selected by the user or randomly assigned by the application 202 during a user profile setup.

The first digital interface 204 of the virtual sound engineer access application 202 includes a chat application window 210. In some instances, the first digital interface 204 includes a video feed window 212. The video feed window 212 may be configured to generate a digital video indicative of a video data captured at one of the first digital mixing site 108a and the second digital mixing site 108b. For example, the first digital mixing console 125 of the first digital mixing site 108a may be equipped with an integrated digital video camera and may be configured to transmit video data captured by the video camera to the virtual sound engineer device 104 to be reproduced within the video feed window 212.

The first digital interface 204 of the virtual sound engineer access application 202 includes a network connection status indicator 214, an audio connection status indicator 216, and a video connection status indicator 218.

FIG. 2B illustrates an example layout 200-B of a second digital interface 220 of the virtual sound engineer access application 202 accessible from the virtual sound engineer device 104. The virtual sound engineer access application 202 may generate the second digital interface 220 in response to the connection being established between the virtual sound engineer device 104 and one of the digital mixing consoles 125, 135 (e.g., according to one or more operations described in reference to at least FIG. 2A). The second digital interface 220 includes a location identifier input field 222. Example location identifier may correspond to, or be associated with, one of the first digital mixing site 108a and the second digital mixing site 108b.

The second digital interface 220 of the virtual sound engineer access application 202 includes a virtual digital mixing console 224. In an example, the virtual digital mixing console 224 may be the first digital mixing console 118a for controlling input and output of the peripheral devices 114 of the first digital mixing site 108a. In another example, the virtual digital mixing console 224 may be the second digital mixing console 118b for controlling input and output of the peripheral devices 116 of the second digital mixing site 108b. To that end, the virtual digital mixing console 224 includes a plurality of controls for controlling input and output of the peripheral devices at one of the first and second digital mixing sites 108a, 108b.

The virtual digital mixing console 224 includes a microphone control 226a, a master volume control 228a, a camera output control 230a, and a pair of stereo controls 232a, 234a. In one example, each of the controls 226a, 228a, 230a, 232a, and 234a includes a corresponding adjustment slider 226b, 228b, 230b, 232b, and 234b. While slider-type adjustments are illustrated, the virtual digital mixing console 224 of the present disclosure is not limited thereto. Example virtual digital mixing console 224 may include more or fewer controls that are same or different control types having same or different adjustment means (e.g., knobs, dials, buttons, and so on).

In one example, the virtual digital mixing console 224 of the virtual sound engineer access application 202 may be configured to receive user (e.g., virtual sound engineer) input indicative of a request to change a position of one or more corresponding adjustment sliders 226b, 228b, 230b, 232b, and 234b of one or more controls 226a, 228a, 230a, 232a, and 234a to balance the sound output by, for example, the peripheral devices 114 of the first digital mixing site 108a. Accordingly, using the second digital mixing interface 220 of the virtual sound engineer application 202, the sound engineer balances the sounds output by microphones, speakers and instruments.

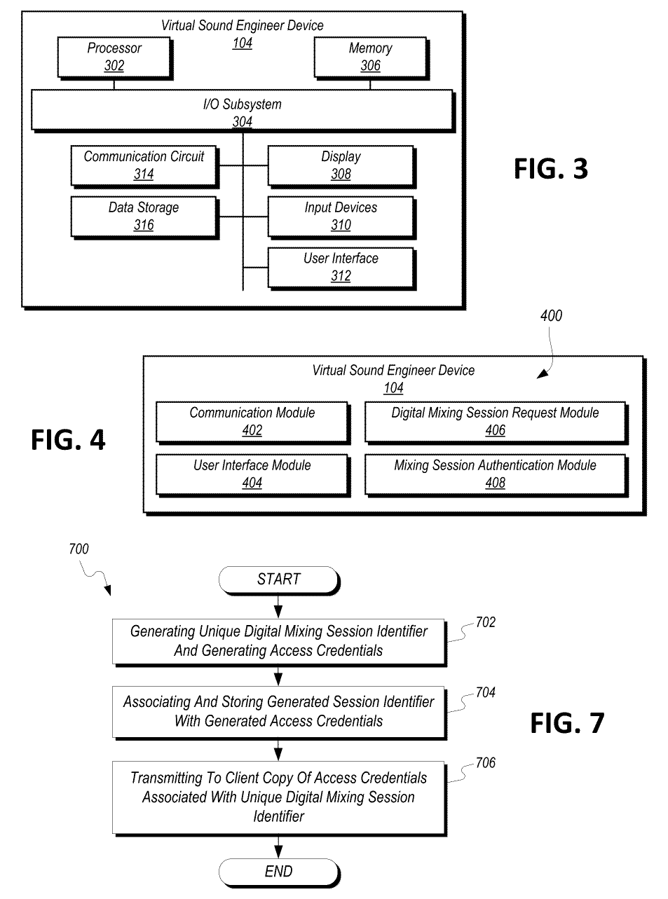

Referring now to FIG. 3, an example virtual sound engineer device 104 is shown and it includes a processor 302, an I/O subsystem 304, a memory 306, a display 308, input device(s) 310, a user interface 312, a communication circuit 314, and a data storage 316. As one example, one or more of the display 308, the input device(s) 310, the user interface 312 may comprise the interface 105 describe in reference to at least FIG. 1. Moreover, while FIG. 3 is directed to the virtual sound engineer device 104, one or more of the user device 140 and the user device 150 may include similar components configured to perform operations as described herein. Of course, in other embodiments, the virtual sound engineer device 104, the user device 140, and the user device 150 may include alternative or additional components, such as those commonly found in a server, router, switch, or other network device. Additionally, in some embodiments, one or more of the illustrative components may be incorporated in, or otherwise form a portion of, another component. For example, the memory 306, or portions thereof, may be incorporated in one or more processors 302.

The processor 302 may be embodied as any type of processor capable of performing the described functions. The processor 302 may be embodied as a single or multi-core processor(s), digital signal processor, microcontroller, or other processor or processing/controlling circuit. The memory 306 may be embodied as any type of volatile or non-volatile memory or data storage capable of performing the functions described herein. In operation, the memory 306 may store various data and software used during operation of the virtual sound engineer device 104, such as operating systems, applications, programs, libraries, and drivers. The memory 306 is communicatively coupled to the processor 302 via the I/O subsystem 304, which may be embodied as circuitry and/or components to facilitate input/output operations with the processor 302, the memory 306, and other components of the virtual sound engineer device 104. For example, the I/O subsystem 304 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 304 may form a portion of a system-on-a-chip (SoC) and be incorporated, along with the processors 302, the memory 306, and other components of the virtual sound engineer device 104, on a single integrated circuit chip.

The display 308 may be embodied as any type of display capable of displaying digital information to a user such as a liquid crystal display (LCD), a light emitting diode (LED), a plasma display, a cathode ray tube (CRT), or other type of display device. As described below, the display 308 may be used to display a graphical user interface or other information to the user of the virtual sound engineer device 104. Additionally, in some embodiments, the virtual sound engineer device 104 may include a touch screen coupled to or incorporated in the display 308. The touch screen may be used to receive user tactile input.

The communication circuit 314 may be embodied as any communication circuit, device, or collection thereof, capable of enabling communications between the virtual sound engineer device 104 and the user devices 140, 150 and/or the digital mixing consoles 125, 135 via the network 112. To do so, the communication circuit 314 may be configured to use any one or more communication technology and associated protocols (e.g., Ethernet, Bluetooth®, Wi-Fi®, WiMAX, etc.) to effect such communication.

The data storage 316 may be embodied as any type of device or devices configured for short-term or long-term storage of data such as, for example, memory devices and circuits, memory cards, hard disk drives, solid-state drives, or other data storage devices. The data storage 316 and/or the memory 306 may store various other data useful during the operation of the virtual sound engineer device 104. As one example, the data storage 316 may store one or more unique digital mixing session identifiers corresponding to one or more remote access digital mixing sessions. As another example, the data storage 316 may store one or more access credentials, such as, passwords, access codes, key phrases, and other authentication parameters in association with each of the one or more mixing session identifiers.

Referring now to FIG. 4, in use, the virtual sound engineer device 104 establishes an environment 400. The illustrative environment 400 includes a communication module 402, a user interface module 404, a digital mixing session module 406, and a mixing session authentication module 408. Each of the modules and other components of the environment 400 may be embodied as firmware, software, hardware, or a combination thereof. For example the various modules, logic, and other components of the environment 400 may form a portion of, or otherwise be established by, the processor 302, the I/O subsystem 304, an SoC, or other hardware components of the virtual sound engineer device 104. As such, in some embodiments, any one or more of the modules of the environment 400 may be embodied as a circuit or collection of electrical devices (e.g., a communication circuit, a user interface circuit, an alert receipt circuit, a user feedback detection circuit, etc.).

The communication module 402 is configured to facilitate communications between the virtual sound engineer device 104 and other devices of the system 100. For example, the communication module 402 may establish communication links, via the communication circuit 314, with one or more of the user device 140, the user device 150, the digital mixing console 125, the digital mixing console 135 to change sound output by one or more peripheral devices connected (either directly or indirectly) thereto.

The user interface module 404 is configured to provide an interface to a user for interaction with the virtual sound engineer device 104. For example, the user interface module 404 may receive user input from the user interface 312 and/or the touchscreen of the display 308. Additionally the user interface module 404 is configured to control or manage the input devices 310. For example, the user interface module 404 may receive or detect a command via the input devices 310 to change sound output by one or more peripheral devices during the first and/or second digital mixing sessions as discussed in more detail below.

The digital mixing session request module 406 is configured to receive, via the communication module 402, data indicating a request for a digital mixing session. The digital mixing session request module 406 is communicatively coupled to the user interface module 404. Upon receiving request for a digital mixing session from one or both of the user devices 140, 150, the digital mixing session request module 406 causes the user interface module 404 to update information rendered on the display 308 as discussed in more detail below.

The mixing session authentication module 408 is configured to generate a unique digital mixing session identifier corresponding to a remote access digital mixing session and generate access credentials, such as, password, access code, key phrase, or another authentication parameter. The mixing session authentication module 408 is configured to associate and store the generated unique digital mixing session identifier with the generated access credentials. The mixing session authentication module 408 is configured to transmit (e.g., via the communication module 402) a copy of the stored access credentials to the client device prior to requesting initiation of a remote access digital mixing session.

The mixing session authentication module 408 is configured to detect whether or not verification credentials provided by the user device (e.g., one of the user devices 140, 150) requesting the digital mixing session match the stored digital session credentials. For example, in response to a request (as indicated, for example, by one or more corresponding signals from the digital mixing session request module 406) to initiate a remote access digital mixing session, the mixing session authentication module 408 is configured to request, from the user device, access credentials associated with the remote access digital mixing session. The mixing session authentication module 408 determines whether access credentials received from the client device (e.g., user device 140 or user device 150) match stored credential associated with the remote access digital mixing session. If the received access credentials do not match the stored credentials, the mixing session authentication module 408 transmits a notification to the client device that the provided credentials were invalid and that the session connection was denied. In response to detecting that the received access credentials match the stored credentials, the mixing session authentication module 408 transmits via the communication module 402 data indicating that the connection has been established and/or the digital mixing session initiated to the user device (e.g., the client device) that requested the digital mixing session.

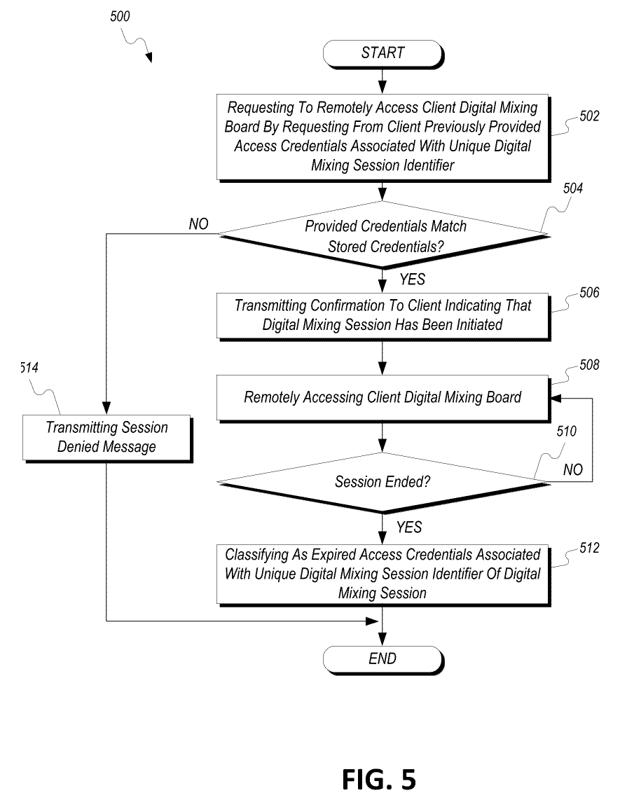

FIG. 5 illustrates an example process 500 for remotely accessing and controlling multiple digital mixing consoles. The process 500 may be executed by one or more components of the remote access digital mixing console application described in reference to at least FIGS. 1, 2A-2B, and 3-4. In one example, the process 500 may be executed by processor 302 of the virtual sound engineer device 104 described in reference to at least FIG. 3. The process 500 begins at block 502 where the processor 302 prepares to initiate a remote access digital mixing session by requesting, from the client device, access credentials associated with the remote access digital mixing session. At block 504, the processor 302 (and/or the mixing session authentication module 408) determines whether access credentials received from the client device (e.g., user device 140 or user device 150) match stored credential associated with the remote access digital mixing session. If the received access credentials do not match the stored credentials, the processor 302, at block 514, transmits a notification to the client device that the provided credentials were invalid and that the session connection was denied. The processor 302 may then exit the process 500.

In response to determining that the received credentials match the stored credentials associated with the remote access digital mixing session, the processor 302, at block 506, transmits a notification to the client device indicating that authentication has been successfully completed and the remote access digital mixing session has been initiated.

At block 508, the processor 302 initiates remotely accessing client digital mixing board, e.g., using remote access environment within the virtual sound engineering application, to monitor operation and control sound balance as output by the sound input and output by peripheral devices connected to the client digital mixing board. In some instances, the processor 302 may be configured to determine, at block 510, whether the remote access digital mixing session has been ended by either the virtual sound engineering application, on one end, or the client device, on the other end. Additionally or alternatively, the processor 302 may be configured to determine whether the remote access digital mixing session has been interrupted due to loss or degradation of network connectivity between the client device and the virtual sound engineer device 104. In response to determining that the session has not been ended, the processor 302 returns to block 508 where the processor 302 continues to remotely accessing client digital mixing board (e.g., digital mixing boards 125, 135) to monitor operation and control sound balance as output by the sound input and output by peripheral devices connected to the client digital mixing board.

In response to determining at block 510 that the session has been ended, the processor 302, at block 512, classifies as expired the stored access credentials associated with the unique digital mixing session identifier of the remote access digital mixing session. In one example, to classify the stored access credentials, the processor 302 may change status identifier corresponding to the stored access credentials from an active status to an expired status. The process 500 may then end. In some instances, the process 500 may be repeated in response to transmitting a request to remotely access the client digital mixing board or in response to a different request.

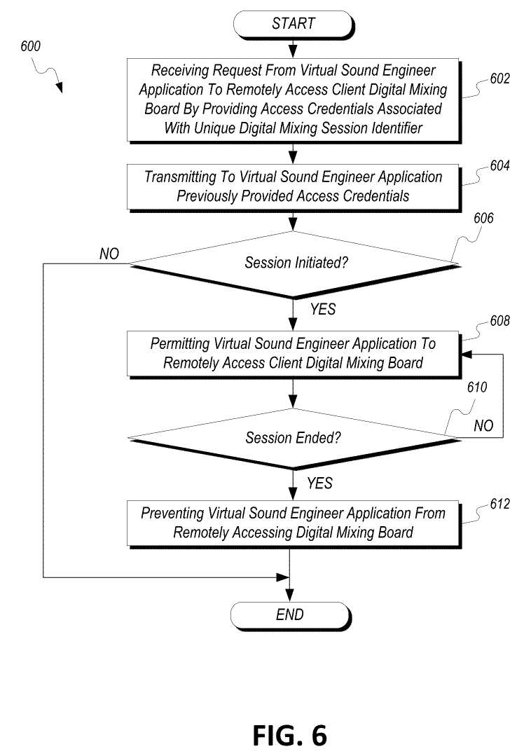

FIG. 6 illustrates an example process 600 for permitting remote access and control of a digital mixing console. The process 600 may be executed by one or more components of the client device and/or a client side of the remote access digital mixing console application described in reference to at least FIGS. 1 and 2A-2B. The process 600 begins at block 602 where the processor 302 receives a request, from the virtual sound engineer application, to initiate a remote access digital mixing session by providing, by the client device, access credentials associated with the remote access digital mixing session.

At block 604, the processor 302 transmits to the virtual sound engineer application previously provided access credentials corresponding to the unique digital mixing session identifier of the remote access digital mixing session. In one example, the processor 302 may be configured to receive the access credentials from the virtual sound engineer application and/or the virtual sound engineer device 104 prior to receiving the request to initiate a remote access digital mixing session. As described in reference to at least FIGS. 4 and 7, the virtual sound engineer device 104 may be configured to generate and store the access credentials corresponding to the unique digital mixing session identifier of the remote access digital mixing session. The virtual sound engineer device 104 may transmit a copy of the stored access credentials to the client device prior to requesting to initiate a remote access digital mixing session. (See, e.g., FIG. 7.)

At block 606, the processor 302 determines whether the authentication of the credentials has been completed and the remote access digital mixing session has been initiated. If the remote access digital mixing session has not been initiated, e.g., upon a corresponding notification from the virtual sound engineer application that session initiation has been denied, the processor 302 may exit the process 600.

In response to determining that the remote access digital mixing session has been successfully initiated, the processor 302, at block 608, initiates permitting remote accessing of the client digital mixing board, e.g., using remote access environment within the virtual sound engineering application, to monitor operation and control sound balance as output by the sound input and output by peripheral devices connected to the client digital mixing board. In some instances, the processor 302 may be configured to determine, at block 610, whether the remote access digital mixing session has been ended by either the virtual sound engineering application, on one end, or the client device, on the other end. Additionally or alternatively, the processor 302 may be configured to determine whether the remote access digital mixing session has been interrupted due to loss or degradation of network connectivity between the client device and the virtual sound engineer device 104. In response to determining that the session has not been ended, the processor 302 returns to block 608 where the processor 302 continues to permit remote accessing of the client digital mixing board, e.g., using remote access environment within the virtual sound engineering application, to monitor operation and control sound balance as output by the sound input and output by peripheral devices connected to the client digital mixing board.

In response to determining at block 610 that the session has been ended, the processor 302, at block 612, prevents remote accessing of the client digital mixing board, e.g., using remote access environment within the virtual sound engineering application, to monitor operation and control sound balance as output by the sound input and output by peripheral devices connected to the client digital mixing board. The process 600 may then end. In some instances, the process 600 may be repeated in response to receiving a request to remotely access the client digital mixing board or in response to a different request.

FIG. 7 illustrates an example process 700 for generating access credentials for remotely accessing multiple digital mixing consoles. The process 700 may be executed by one or more components of the remote access digital mixing console application described in reference to at least FIGS. 1 and 2A-2B. The process 700 begins at block 702 where the processor 302 generates a unique digital mixing session identifier corresponding to a remote access digital mixing session and generates access credentials, such as, password, access code, key phrase, or another authentication parameter. At block 704, the processor 302 is configured to associate and store the generated unique digital mixing session identifier with the generated access credentials. At block 706, the processor 302 transmits a copy of the stored access credentials to the client device (e.g., the user device 140 and the user device 150) prior to requesting initiation of a remote access digital mixing session. The process 700 may then end. In some instances, the process 700 may be repeated in response to generating a unique digital mixing session identifier corresponding to a remote access digital mixing session or in response to a different request, action, or command.

Illustrative virtual sound system includes a digital mixing console configured to communicatively coupled to a mobile device, a wireless router connected, via a network, to the digital mixing console, a virtual sound engineer application installed on the mobile device and configured to receive user input and a digital mixer application configured to receive user input to control the digital mixing console.

A method for operating the virtual sound system includes powering on a digital mixing console, powering on a public address (PA) system, connecting a router to the digital mixing console, connecting the router to a network and connecting an onsite mobile device to the same network, launching a digital mixer application on the onsite mobile device, wherein the digital mixer application is configured to monitor and control operation of the digital mixing console. The method includes launching a virtual digital sound engineer application on the onsite mobile device and, in response to receiving an access code and password, using the received credentials to authorize remote management of the digital mixing console.

The method for operating the virtual sound system includes launching the virtual sound engineer application on a remote mobile device and sending a request to the onsite mobile device to access the virtual digital sound engineer application on the onsite mobile device, wherein the request includes an access code and password. In response to a confirmation that a connection with the onsite mobile device has been established, controlling, from the remote mobile device, the digital mixing console using the virtual sound engineer application.

MQTT (Message Queue Telemetry Transport) protocol and Java Spring Boot for Server Application. Establishing an MQTT session includes establishing a connection between a publisher and a subscriber. For example, the publisher opens the application and connects with a remote server. Upon establishing a connection with the publisher, the server assigns a unique session identifier to the publisher. The subscriber opens the application and connects with the server, and the server assigns a unique session identifier to the subscriber. The publisher shares this unique session identifier with the subscriber and the subscriber inputs the shared unique session identifier to connect with the publisher. The server validates the unique session identifier provided by the subscriber and, in response to the provided unique session identifier matching the assigned unique session identifier, the server connects the publisher and the subscriber.

MQTT session between server, publisher and subscriber, the server validates session detail of publisher and subscriber and establishes connection between them; the subscriber requests for session data; the publisher submits session data; the subscriber application renders session data into the actual screen of the application; the subscriber sends packets (issues commands) to the publisher; the subscriber controls publisher device; the publisher continuously sends packets; the subscriber continuously receives packets; the publisher and subscriber receives connection acknowledgement to publish packets. The server terminates the connection in response to detecting that one of the publisher and the subscriber disconnected from the session.

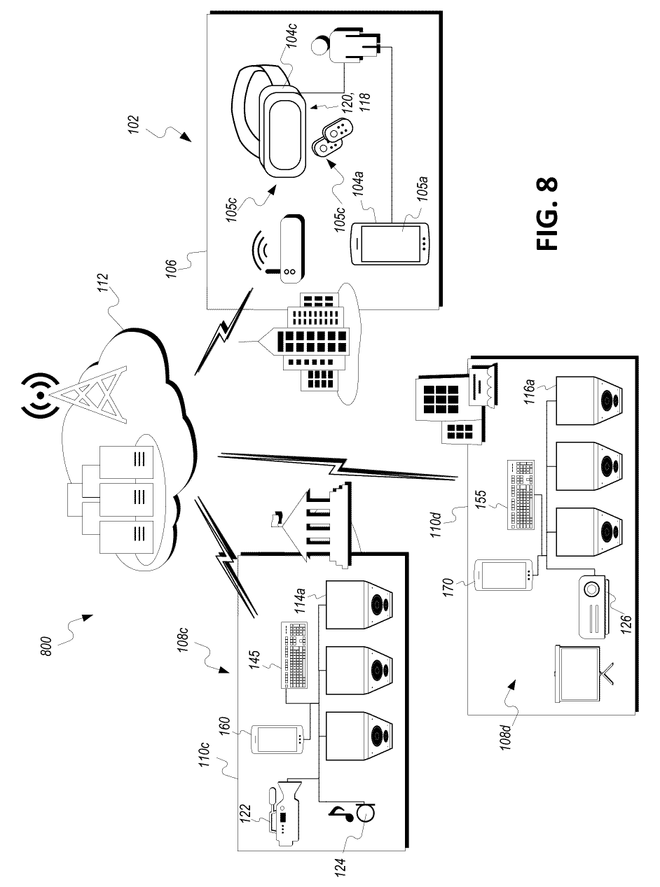

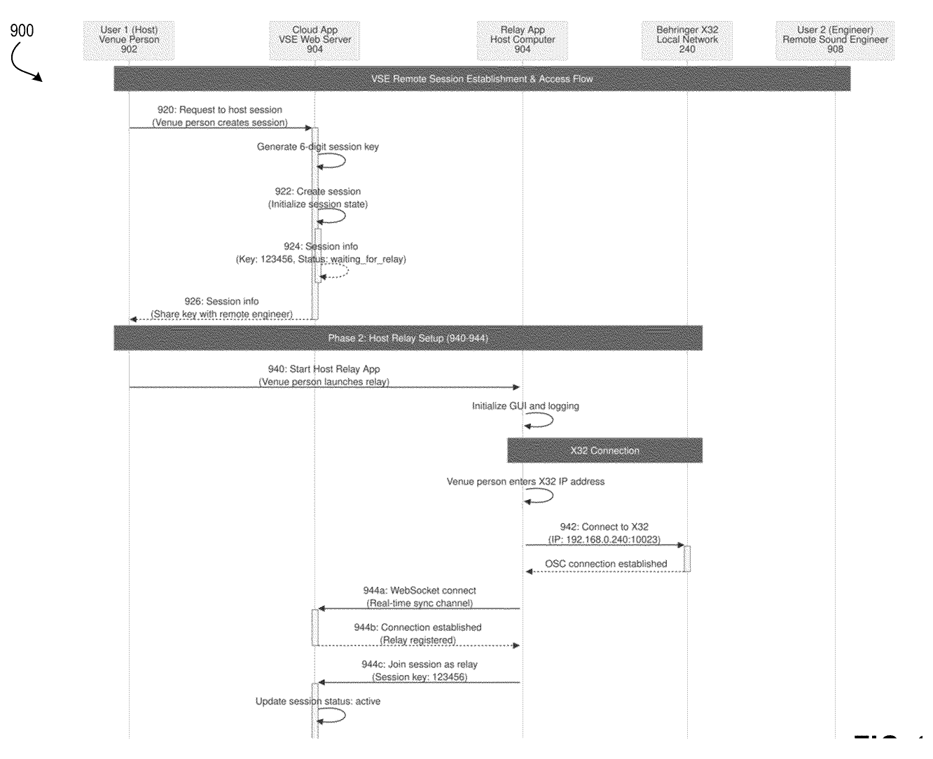

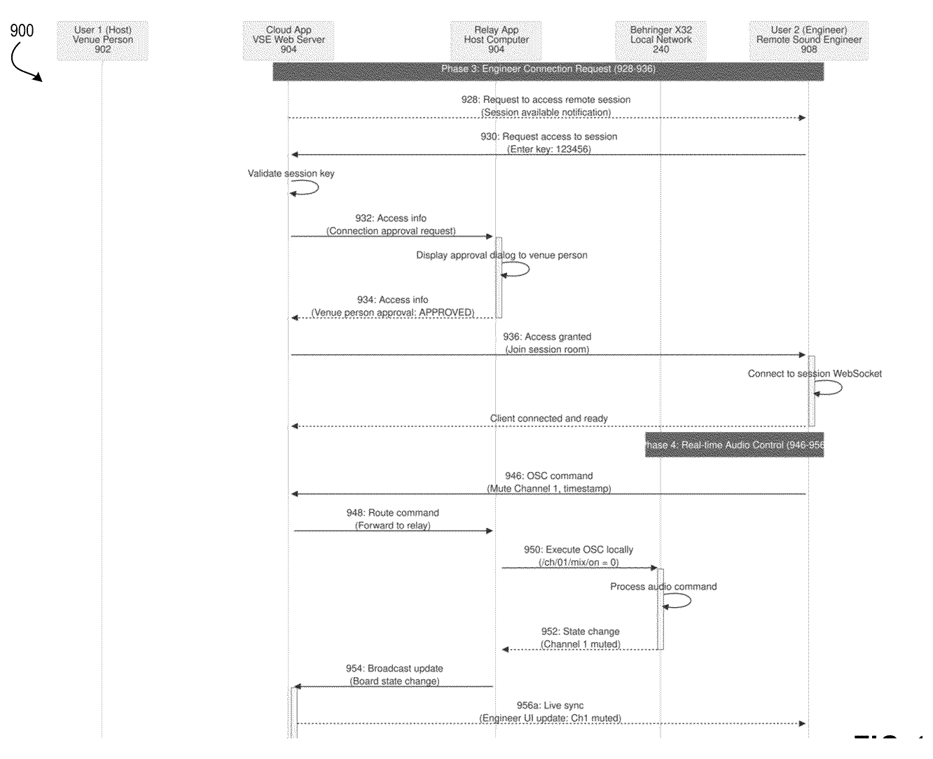

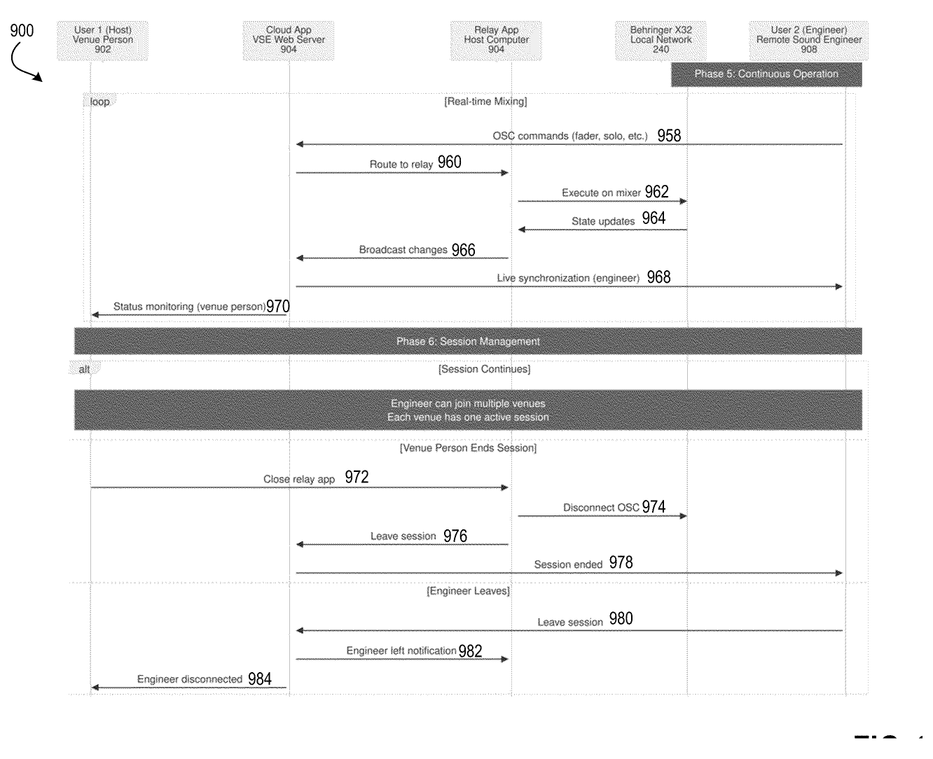

FIG. 8 depicts another illustrative system 800 for monitoring and controlling, from a remote location, sound input and output by peripheral devices located at different geographic locations from one another and from the remote location. The system 800 is similar to the system 100 and includes many of the same or similar devices and/or components, such as the virtual sound engineer system 102, the virtual sound engineer devices 104, the remote location 106, the digital mixing sites 108, and the network 112. Accordingly, the description above in connection with FIG. 1 is applicable to the corresponding devices and/or components of FIG. 8 and is not repeated herein so as not to obscure the present disclosure.

As shown in FIG. 8, the illustrative virtual sound engineer system 102 includes virtual sound engineer devices 104a, 104c. As described above, the virtual sound engineer device 104 may be embodied as a mobile or stationary device such as a computer, a smart phone, a tablet computer, a laptop computer, a notebook computer, a mobile computing device, a desktop computer, a work station, a cellular telephone, a handset, a messaging device, a vehicle telematics device, a network appliance, a web appliance, a distributed computing system, a multiprocessor system, a consumer electronic device, a digital television device, and/or any other computing device. The virtual sound engineer device 104c may be embodied as a head-mounted display, a heads-up display, a virtual reality device, augmented reality device, mixed reality device, a wearable device, or any other virtual reality device. Although illustrated as including separate virtual sound engineer devices 104a, 104c, in some embodiments the virtual sound engineer device 104c may be a standalone device including the virtual sound engineer access application 120.

The virtual sound engineer device 104c may provide access to the virtual sound engineer access application using one or more audio and visual output devices, such as, but not limited to, a head-mounted stereoscopic display, which may include one or more display screens and associated optics (e.g., aspheric lenses, Fresnel lenses, or similar). The virtual sound engineer device 104c may also include audio and visual output devices such as speakers and displays, and one or more audio and visual input devices, such as, but not limited to, microphones and cameras. The virtual sound engineer device 104c may receive user input using one or more user input interfaces 105, such as, but not limited to one or more physical controller devices 105c as shown in FIG. 8. Additionally or alternatively, the virtual sound engineer device 104c may be configured to perform speech, face, and hand gesture recognition and/or receive user input by way of voice commands, stylus inputs, single- or multi-touch gestures, and touchless hand gestures.

As shown in FIG. 8, the virtual sound engineer system 102 is disposed at the remote location 106. An additional digital mixing site 108c is located at a location 110c and a further additional digital mixing site 108d is located at a location 110d, where each of the locations 110c, 110d are different from one another and from the remote location 106. Each of the digital mixing sites 108c, 108d include corresponding user devices 160, 170, which are similar to the user devices 140, 150 described above. The user device 160 of the digital mixing site 108c is communicatively coupled to a digital mixing console 145 of the mixing site 108c, wherein the digital mixing console 145 is communicatively coupled to at least one peripheral device 114. Similarly, the user device 170 of the digital mixing site 108d is communicatively connected to a digital mixing console 155 of the mixing site 108d, wherein the digital mixing console 155 is communicatively coupled to one or more peripheral devices 116 of the mixing site 108d.

As shown, the digital mixing site 108c further includes audio and video input devices 122, 124, respectively, which may embodied as a video camera 122 and a microphone 124. The audio-video devices 122, 124 are configured to capture audio and video data indicative of the environment of the digital mixing site 108c, for example, views and/or audio from the interior of the location 110c. The audio-video devices 122, 124 are illustrated as being coupled to the digital mixing console 145; however, in other embodiments the audio-video devices 122, 124 may be coupled directly to the user device 160.

Similarly, the digital mixing site 108d further includes an audiovisual presentation device 126, which is illustratively embodied as a projector. In some embodiments, the audiovisual presentation device may be embodied as a display screen, television, monitor, laptop computer, or any other video and/or audio device or devices capable of displaying audiovisual presentation content at the digital mixing site 108d. The audiovisual presentation device 126 is illustrated as being coupled to the digital mixing console 155; however, in other embodiments the audiovisual presentation device 126 may be coupled directly to the user device 170.

As described above, the virtual sound engineer system 102 is configured to monitor and control sound output by one or more peripheral input and output devices 114, 116 communicatively coupled to the digital mixing console 145 of the digital mixing site 108c and the digital mixing console 155 of the digital mixing site 108d, respectively.

In an example, a client device the digital mixing site 108c (e.g., the client device 160) signs into the virtual sound engineer access application 120 and requests an access code. The virtual sound engineer device 104c receives a notification of the access code request and displays the notification in a virtual reality environment using the interface 105c. The virtual reality environment may be embodied as a metaverse or other virtual world that renders an immersive, three-dimensional representation of the real world (or an imagined world). After rendering the notification, the virtual sound engineer device 104c may send the requested authorization code to the client device 160 to complete the remote access digital mixing session connection.

In an example, the virtual sound engineering system 102c is configured to generate, a digital mixing console 118 including one or more controls for controlling input and output of the peripheral devices 114 of the digital mixing site 108c. The digital mixing console 118 may comprise a virtual digital mixing console, including one or more three-dimensional digital renderings, reproductions, or representations, whether exact or approximate, of the digital mixing console 145. Additionally or alternatively, the digital mixing console 118 may comprise a virtual or other three-dimensional digital representations indicative of remote access (by the virtual engineer device 104c) of the user device 160 connected to the first digital mixing console 145. In some instances, the digital mixing console 118, as rendered on the interface 105c, may include either same or different number (whether more or fewer) of controls as the digital mixing console 145. As just one example, one or more controls of the digital mixing console 145, as rendered on the interface 105c, may be arranged differently from corresponding controls of the digital mixing console 145.

Once the remote access digital mixing session connection is confirmed, the virtual sound engineer device 104c has visual and audio access to the session location 110c via the interface 105c via the virtual reality environment. For example, the virtual sound engineer device 104c may render a three-dimensional representation of the location 110c using real-time video and/or audio data captured at the location 110c. Visual access may be granted through an onsite camera, such as the video camera 122. The virtual reality environment may thus reflect the layout of the location 110c room including floors, walls, ceilings, furniture and/or equipment. Audio access may be granted through one or more peripheral devices 114 coupled to the digital mixing console 145 and/or through the microphone 124 that captures audio in the room. This multiple audio feed feature may allow the user to toggle between digital mixing console 145 audio and room audio while in the virtual reality environment. By having both room and mixing console 145 audio available, the system 100 allows the user to make necessary adjustments to the mixing console 145.

The virtual sound engineer device 104c may also provide one or more two-way communication channels between the session location 110c and the remote location 106. For example, the virtual sound engineer device 104c may provide a text chat feature, similar to the chat application 210, in the virtual reality environment. In some embodiments, the virtual sound engineer device 104c may provide a talk-back feature to allow the sound engineer at the remote location 106 to communicate with the client at the session location 110c directly by voice during the session.

In addition to remotely managing a single session, the virtual sound engineer access application 120 also gives the user at the virtual sound engineer device 104c the ability to manage multiple sessions, in different locations 110 at the same time. Each of those sessions may be rendered in the same virtual reality environment.

Additionally or alternatively, as another example, the virtual sound engineer access application 120 may allow the virtual sound engineer device 104c the ability to control audio and visual presentations at the site 110d. Many events include an audiovisual presentation device 126 such as a projector, and may require a sound engineer to manage the sound for the presenters and audience. Accordingly, after establishing a remote access digital mixing session connection between the virtual sound engineer device 104c and the user device 170 at the location 110d, the virtual sound engineer device 104c may control the presentation by the presentation device 126. For example, the virtual sound engineer device 104c may start the presentation, stop the presentation, move to the next or previous slide, or otherwise control the operation of the presentation device 126. In addition to managing the presentation, virtual sound engineer device 104c may play coordinated sounds or music with the presentation and otherwise control audio at the site 110d. This presentation control interface may be provided in a virtual reality environment as described above and/or with another interface 105 of the virtual sound engineer device 104.

Thus, the system 100 as described above may allow a sound engineer to control digital mixing consoles at multiple locations that are widely geographically spaced. The virtual reality environment or metaverse interface may provide efficient and intuitive control of multiple digital mixing consoles, and may allow the sound engineer to responsively control the digital mixing console based on conditions at the mixing session location (which may be different from the remote location). Further, the system 100 may provide integrated presentation and audio mixing control with a remote sound engineering session, which may improve presentation quality as compared to presentations that do not employ a sound engineer.

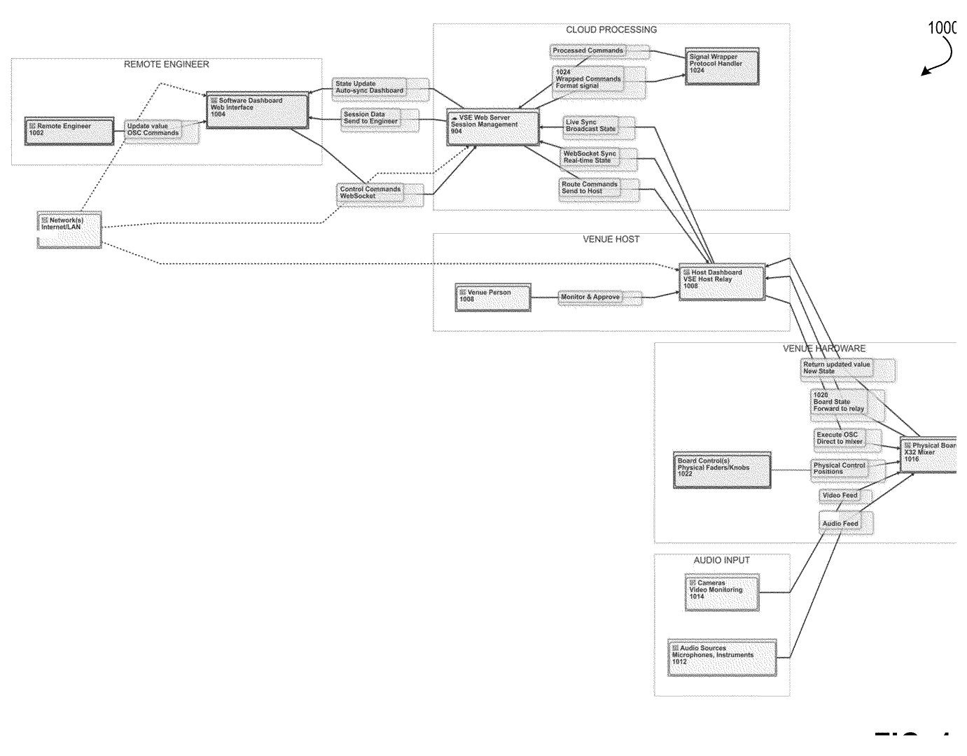

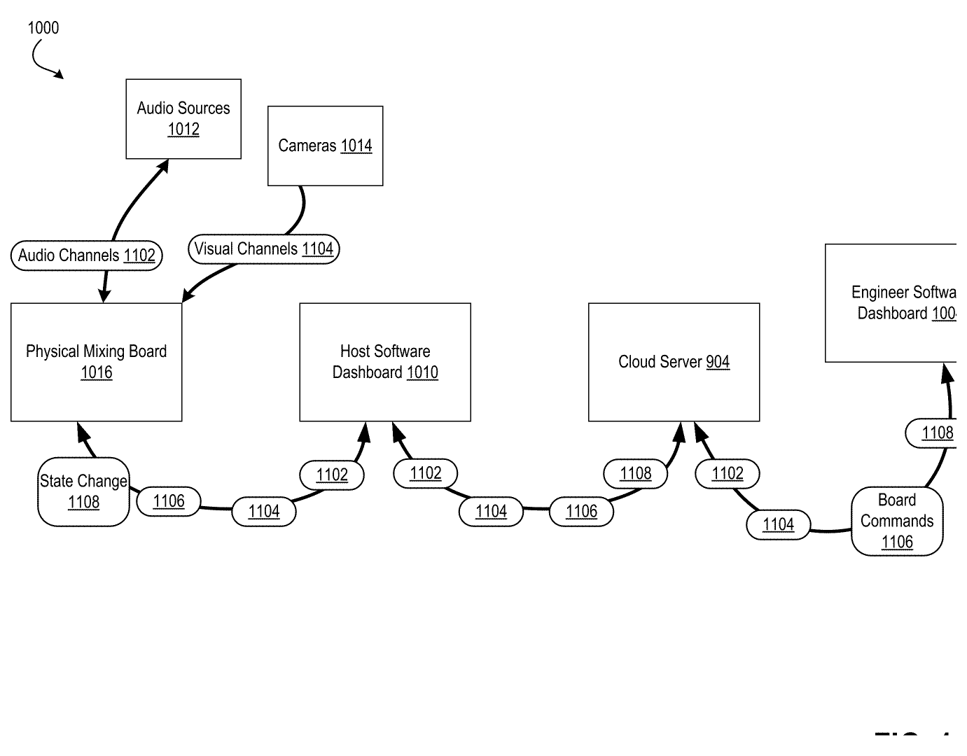

FIGS. 9A, 9B, and 9C illustrate an example process 900 for establishing, maintaining, and ending a remote connection to control a physical mixing board. The process 900 can provide improvements in communication between devices (e.g., user devices, remote devices) and mixing boards (e.g., a physical mixing board) to reduce or otherwise eliminate lag. Such improvements can generally eliminate translation at a remote server or device and instead provide for direct communication between devices (e.g., user devices, remote devices) and the physical mixing board at a location to reduce or otherwise eliminate lag.

Moreover, the disclosed process 900 provides additional session security features: 6-digit session keys with 24-hour expiration (or other predetermined-length session keys and expiration time periods), approval for all remote connections required by a venue/host user at the venue location, session isolation to prevent cross-interference, and encrypted communications between the components described herein (e.g., HTTPS/WSS). The process 900 also provides unique network architecture features: OSC commands that stay on the local network 240, a cloud server/web server that only coordinates session management, automatic reconnection in response to network issues, and graceful degradation of a connection/session when a network connection is lost. The process 900 further provides real-time performance features: local OSC execution for minimal latency, timestamp tracking for performance monitoring, delta updates to maximize bandwidth, and live synchronization across all client user devices.

In the example process 900, a first user device 902, a cloud server application and relay application 904, and the local network 240, and a second user device 908 can be in network communication with each other (e.g., wired, wireless). Similar to the techniques described above, the components in the process 900 can communicate with each other to control sound at a location, such as during a live event. The components described with respect to the process 900, more particularly, can be configured to communicate with each other in order to provide remote control of the sound at the location in such a way that reduces bandwidth and lag, thereby allowing for real-time remote control of the sound. In brief, the first user device 902 can be associated with a host or other user at a physical location/venue of a sound event. The cloud application 904 can be hosted by a virtual sound engineering web server, such as the virtual sound engineer system 102 described herein. The relay application 904 can be provided by the virtual sound engineering web server to the user device 902 and thus hosted by the user device 902. The second user device 908 can be any computing system of a remote engineer or other user that is requesting access to manage/control the sound at the physical location.

Referring to the process 900 in FIGS. 9A, 9B, and 9C, a virtual sound engineer remote session can be stablished and accessed in a first phase in 920-926. The first user device 902 can transmit a request to host a session for controlling the sound (920). In other words, the user/host at the venue location can open/access a virtual sound engineer web interface described herein at the first user device 902 and provide user input to create a new mixing session. The cloud server application 904 can receive the request and process the request (922) by creating a session. Creating the session can include generating a session key, such as a 6-digit alphanumeric code that serves as the session key. Creating the session can also include initializing a state of the session and other session metadata. The session metadata can include the session key, a host connection identifier (e.g., initially may be empty and can be populated when a connection is established), a relay connection status (e.g., initially inactive), a client list (e.g., to track joining users), a creation timestamp, and/or an activity timestamp (e.g., for automatic cleanup). Sometimes, the cloud server application 904 can store the session metadata in a database to then be distributed to a state management system with a tine-to-live (TTL) for automatic expiration. Creating the session can also include creating an active sessions index. In other words, the application 904 can add the session key to the index of active sessions for monitoring and managing the particular session. The process of session information generation can be performed quickly by leveraging the distributed state management system’s performance to ensure the session is immediately available for other users to join in real-time.

In response to creating the session, the cloud application 904 can generate (924) and return (926) session information in to the user device 902. The session information can include any portion of the session metadata, such as the 6-digit session key and/or a status or state of the session (e.g., waiting for relay, pending, active, expired). The session information can include the server endpoint (e.g., network address for establishing real-time communication), an authentication token (e.g., cryptographic token for connection authorization), the session expiration information (e.g., timestamp(s) indicating when the session will automatically expire), capabilities (e.g., available features for the particular session such as audio channels, video channels, and/or control permissions), and/or the region information (e.g., geographic region of the server for latency optimization).

The session information can enable the user device 902 to establish the real-time connection and share the access code with devices of remote sound engineers and/or other users/clients who may wish to join the session. Sometimes, the session information can include unique identifiers (IDs) for users that are or can be granted access to the particular session. Of the session information that is transmitted to the user device 902, the session key may also be shared with a remote engineer at the second user device 908, as described further below. The cloud server application 904 can also confirm the session creation with the key and the status.

A host relay can be set up in a second phase in the process 900, as shown by 940-944. The first user device 902 can start or launch the cloud server application 904 (e.g., host relay application) in 940. In some implementations, the user/host at the first user device 902 can provide input to start a virtual sound engineer host relay desktop application. This action can result in launching a relay for the first user device 902 at the venue location. The cloud server application 904 can then initialize one or more GUIs at the first user device 902 and begin logging activity and interactions of a user at the user device 902 with components presented in the GUIs. An X32 connection (e.g., a connection with a digital mixer) can be established, in which the user at the user device 902 inputs an X32 IP address using the components presented in the GUIs of the cloud server application 904. The provided IP address can be used to establish an open sound control (OSC) connection (e.g., to a sound board/digital mixer at the venue location) via the local network 240 (942). The OSC connection can be a lightweight, message-based protocol where each message has a path and optional arguments (e.g., numbers, strings). The OSC connection can be stateless, since there’s no TCP-style session. Instead, datagrams can simply be sent and received.

The OSC connection establishment can result in a WebSocket connect with the cloud server 904, thereby causing a real-time sync channel (944a). Once the connection is established, the relay can be registered between the web server 904 and the cloud server application 904 (944b) and the cloud server application 904 can join the session as the relay using the session key (944c). Once the cloud server application 904 joins the session, the web server 904 can update the session status, such as to active. A confirmation that the user via the cloud server application 904 joined the session can be transmitted to and presented in the GUIs of the cloud server application 904, indicating that the session status is active (944d). In other words, a connection is established between the first user device 902 and the mixing board/soundboard at the venue location.

An engineer connection request can be established in a third phase, as shown by 928-936 in the process 900. A request to access a remote session can optionally be made between the web server 904 and the second user device 908 of the remote engineer (928). In other words, the web server 904 can transmit a notification to the second user device 908 indicating that the session is available for remote access. The second user device 908 can transmit a request to access the session to the web server 904 (930), which can sometimes include a key for accessing the session (e.g., a session key or other key that was provided by the first user device 902 in 926.

The web server application 904 can validate the key provided by the second user device 908. As described herein, the cloud server application 904 can grant access to an existing session for one or more user devices. Granting access can include performing a session validation operation in which the application 904 receives the session key from the second user device 908 and queries the distributed state management system to verify that the corresponding session exists and has not yet expired. If the session exists, the application 904 can place the second user device 908’s request into a pending approval queue associated with that session key.

Once the key is validated the web server 904 can provide access information, such as a connection approval request, to be presented in the GUIs of the cloud server application 904 at the first user device 902 (932). The connection approval request can include information such as the requesting user’s identifier, a timestamp of the request, and/or a requested permission level (e.g., full control, partial control, view-only). The cloud server application 904 can display the request to the user at the first device 902 and receive input from the user that can be transmitted to the web server 904 (934) (e.g., input provided via a desktop application dialog). The input can include access information such as an approval of the requested remote access.

Access can be granted by the web server 904 to the second user device 908 of the remote engineer (936), which can allow the second user device 908 to join the session room/location. The web server 904 can transmit an access confirmation to the second user device 908. The access confirmation can include access information such as the access token (e.g., cryptographic token authorizing the client’s connection), the session metadata (e.g., current mixing board configuration, connected peripheral devices, active channels), the server endpoint (e.g., network address for establishing the real-time control connection), the permission level(s) (e.g., specific controls available to the second user such as fader control, mute/solo, EQ adjustments, effects routing), active participants information (e.g., list of other users currently in the session for collaboration awareness), a mixing board state (e.g., current positions of faders, mute states, effects settings), and/or audio/video channel information (e.g., available media streams from the mixing board location).

In some implementations, the access information can be transmitted to both the first user device 902 and the second user device 908. The second user device 908 of the remote engineer may use the access information to enable their device to establish a control connection and begin sending mixing board commands. The first user device 902 of the host can receive the information as a confirmation that the remote engineer has been granted access and is now connected. Therefore, the information sent to the first user device 902 can include confirmation that the remote access is now active, an identity of the newly connected user, an updated participant list for the session, and/or visual indicators in the host’s dashboard showing that the remote engineer is connected.

Accordingly, the second user device 908 can connect to the session WebSocket channel described above, thereby establishing that the second user device 908 is connected and ready to interact/communicate with the physical mixing board at the venue location. In some implementations, a one-to-one relationship can exist between the first user device 902 and a session. A one-to-many relationship can exist between the second user device 908 and sessions. Upon approval and granting access to the second user deice 908, the web server application 904 can add the second user’s connection identifier to the session’s client list, generate a reverse mapping for rapid session lookup, and/or update the session’s activity timestamp.

During a fourth phase in the process 900, real-time audio control can occur (946-956). Once the connection is established in the third phase described above, the second user device 908 can transmit OSC commands to the web server 904 during the live sound event at the venue location (946). An illustrative command can include muting a first channel. The command can include one or more timestamps, indicating when the command was made relative to the live sound. The web server 904 can route the command forward to the relay (e.g., the GUIs of the cloud server application 904 presented at the first user device 902) (948), which can execute the command locally at the physical mixing board via the local network 240 (950). The local network 240 can be configured to process the command (e.g., audio command) to effect a state change at the physical mixing board, as described herein. As a result, a state change can be made and provided back to the cloud server application 904 (952). Information about the state change can be presented in the GUIs of the cloud server application 904, such as an indication that the channel 1 was muted. This update can also be broadcasted to the web server 904 (954), thereby indicating that a board state change was made. A live sync can be performed by the web server 904 to cause an update to be presented, in real-time or near real-time, in the GUIs at the second user device 908 (956a) and the first user device 902 (956b). As a result, both the remote engineer and the host/user at the venue location an see that the change was made (e.g., channel 1 was muted).

In the process 900, a fifth phase of continuous operation (958-970) can also be performed. During the fifth phase, real-time mixing can occur. For example, the second user device 908 can transmit any quantity of OSC commands to the web server 904 (e.g., fader, solo, mute) (958). The web server 904 can route those commands, as they come in, to the relay of the cloud server application 904 (960) to cause the cloud server application 904 to automatically execute the command(s) on the physical mixing board via the local network 240 (962). The automatic execution can be locally performed for minimal latency and real-time changes. Status updates can be transmitted from the local network 240 back to the cloud server application 904 (964) based on executing the command(s). The changes made to the physical mixing board can then be broadcasted from the cloud server application 904 to the web server 904 (966), which can be used by the web server 904 to provide live synchronization of information presented at the GUIs of the second user device 908 (968) and the first user device 902 (970). The information presented at the GUIs of the first user device 902 can provide for live status monitoring of actions being taken by the remote engineer to control the sound during the live session at the venue location.

Session management can optionally continue in a sixth phase of the process 900 using the techniques described above. Performance monitoring and/or optimization can also be performed throughout the session.

As mentioned, the remote engineer at the second user device 908 can join sessions at multiple venue locations. The remote engineer can then manage sound for multiple sessions or multiple venues. Each venue can have one active session. In some illustrative examples, a venue location could have multiple active sessions (e.g., the location has multiple rooms or stages, each of those having a respective active session).

At some point, the host at the first user device 902 can end the session. To do so, the first user device 902 can close the relay application (e.g., the cloud server application 904) presented in the GUIs at the first user device 902 (972). As a result, the cloud server application 904 can disconnect the OSC connection via the local network 240 to the physical mixing board (974). Accordingly, the cloud server application 904 can leave the session with the web server 904 (976). Session ended information can be transmitted to and presented at the second user device 908 (978) to cause the second user device 908 to leave the session (980). A notification can be generated by the web server 904 and presented in the GUIs of the cloud server application 904 at the first user device 902 to indicate that the remote engineer at the second user device 908 has left the session (982). An engineer disconnected notification can also be transmitted from the web server 904 to the first user device 902 for presentation therein (984). In some implementations, the session can end based on the remote engineer at the second user device voluntarily leaving. Sometimes, the session can automatically timeout after some predetermined period of time, such as after 10 hours, 12 hours, 20 hours, and/or 24 hours. One or more other periods of time can be established for a particular venue location, event, and/or host. In yet some implementations, the session can end with a network disconnection and a graceful recovery.

FIG. 10 is a conceptual diagram of a system 1000 for sending commands remotely to a physical mixing board 1016. The system 1000 illustrates an example host relay architecture for signal flow between system components. Operations described in reference to FIG. 10 can be performed once a remote session connection is established and granted as described with reference to at least FIGS. 9A, 9B, and 9C.

A flow of signals between the system components can begin with real-world audio being captured at a venue location. Sometimes, video may additionally or alternatively be captured. The audio and/or video can be captured by audio sources 1012, cameras 1014, and/or a physical mixing board 1016. The audio sources 1012 can include but are not limited to microphones, instruments, and/or playback devices fed into the physical mixing board 1016. The cameras 1014 can be configured to provide video feeds for monitoring and/or recording. The physical board 1016 can sometimes be an X32 mixer. The physical board 1016 can be configured to process all live audio signals.

Signal processing techniques can then be performed. The signal processing can begin with board state extraction (1020). The physical board 1016 can process the audio feed and track all related control positions. Board controls (1022) can also be captured at the physical board 1016, such as physical fader and/or knob positions being captured. A current mixer state can then be sent or forwarded to a host dashboard relay 1008.

At a host processing layer (1008), a user at the venue location can monitor the session and/or approve remote engineer connections. A desktop application or other dashboard application presented at a device of the user can provide a network connection bridge between the physical mixing board 1016 and the web server 904. For example, and as described in reference to the process 900 in FIGS. 9A, 9B, and 9C, a bidirectional WebSocket connection can be established between the host processing layer (1008) and the web server 904, thereby allowing for real-time synchronizations to occur. An OSC bridge can also be established to provide direct communication with the physical board 1016.

At the web server layer (904) (e.g., a cloud coordination layer), the web server 904 can be configured to handle session keys and user authentication (e.g., authentication of a remote engineer requesting to access the session). The web server layer can also provide command routing to route remote engineer commands to appropriate host relays. Session management techniques can be performed at the web server layer, which can allow for coordination of multiple remote engineers and venue locations. Moreover, the web server layer can utilize a protocol wrapper 1024 for secure cloud transmission of data, commands, and/or other information relating to the live session. The protocol wrapper 1024 can include command wrapping (e.g., wrapping OSC commands in JSON for web transport). Sometimes, the protocol wrapper 1024 can include authentication operations for the session key and/or remote user validation. As another example, the protocol wrapper 1024 can include compression, such as WebSocket compression for bandwidth optimization. The protocol wrapper 1024 can include error handling for comprehensive error detection and/or recovery.

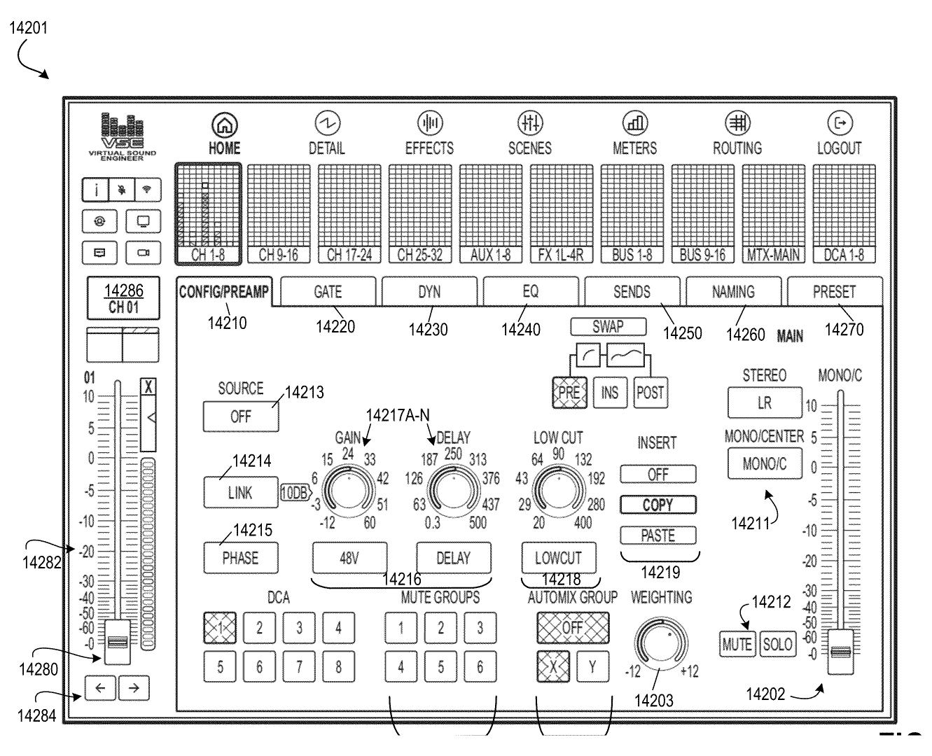

The system 1000 can also include a remote engineer interface layer (1002-1004). The remote engineer 1002 can be physically remote from the venue location, as described herein. A software dashboard 1004 can be presented in one or more GUIs at a user device of the remote engineer 1002, which can provide a browser-based mixer control panel (refer to at least FIGS. 13A and 13B for further discussion). The remote engineer 1002 can provide user inputs in the dashboard 1004 (e.g., via the web interface) in order to adjust mixer controls. The adjustments to controls can be provided in a signal packet 1020 to the web server 904, through the host relay 1008, to the physical board 1016. The signal packet 1020 can include, as an illustrative example, the session key, a timestamp, board states, and/or command IDs. The board state can include instructions for adjusting one or more levels/controls on the physical board 1016, including but not limited to faders, mutes, and/or equalizer(s). The dashboard 1004 can advantageously allow the remote engineer to connect to multiple sessions simultaneously.

A web browser at devices of the remote engineer 1002 and/or the venue host/user 1008 can be used to handle a direct line of communication for audio channels, video channels, and/or transmission of other messages described herein. Accordingly, instead of screensharing the physical mixing board 1016 at the remote sound engineer 1002’s device, the settings, controls, and configuration of the physical mixing board 1016 can be redeveloped in the web portal via the cloud server 904 such that the local host device 1008 can easily view the settings, controls, and configuration of the physical mixing board 1016. Using the cloud server 904, updates made to the physical mixing board 1016 can be provided in messages to both the local host device 1008 and the remote sound engineer 1002’s device such that the updates may be viewable at both devices. This display of same information at both devices can provide for immediate feedback, especially in scenarios where there may be a potential communication barrier with the remote sound engineer 1002’s device (e.g., delays or other interruptions in network communication). As a result, and if needed, a user at the host device 1008 could override controls and adjust the physical mixing board 1016 in real-time.

Once a connection is established, as shown and described herein, the cloud server 904 can format/process and forward controls or other messages from the sound engineer 1002’s device to the host device 1008 for execution at the physical mixing board 1016. The host device 1008 can act as a relay to the mixing board 1016 (rather than acting as a processor), which provides a more direct communication between the mixing board 1016 and the remote sound engineer 1002’s device to reduce lag time. The cloud server 904 can forward these packets of formatted data via local network connections. As described above, the cloud server 904 can forward the packets of formatted data to the host device 1008, which can then transmit the packet(s) to the physical mixing board 1016 for execution. In some implementations, the cloud server 904 can have direct communication to the physical mixing board 1016 and thus can transmit the packet(s) directly to the physical mixing board 1016 rather than going through the host device 1008.

The cloud server 904 can be configured to format the board control(s) 1022 in the signal packet using the protocol wrapper 1024 described above, before directing the wrapped and formatted signal in the signal packet 1020 to the host device. The wrapper 1024 can define metadata, a target recipient of the board control(s) 1022, and/or signal descriptors. The signal descriptors can further include information about a type of signal and/or type of control(s) to be executed at the physical board 1016. When the board control(s) 1022 is wrapped with the wrapper 1024, a payload in the signal packet 1020 can include the actual board control(s) 1022 instructions and related data.

As described herein, the system 1000 can provide a more direct and efficient communication channel between the remote sound engineer 1002’s device and the physical mixing board 1016, thereby reducing or eliminating latency in control and feedback. To achieve this, the physical board 1016’s native communication can be reverse engineered by using packet sniffing techniques. The low-level data packets being exchanged between the board 1016 and the software dashboard 1004 (e.g., web interface) can be analyzed, identifying minimal signals (e.g., a couple of bytes per action) that may control specific channels and functions, such as muting. Existing software solutions may introduce lag by transmitting large, pre-formatted updates. The disclosed technology, on the other hand, can bypass this overhead by replicating the packets needed for the physical mixing board 1016 to interpret and respond in real-time or near real-time. By sending only essential data, such as a two-byte instruction targeting a specific channel and/or action, the system 1000 can be used to trigger updates on the board 1016 directly, and then receive concise confirmation packets to reflect the change visually on the remote software dashboard 1004. This lightweight communication model can therefore reduce an amount of data being transmitted, improving speed and responsiveness. The approach leverages the board 1016’s predefined packet structure to streamline the process, avoiding the need for more resource-heavy data exchanges that previously caused noticeable lag.

Upon receiving the signal packet 1020, the host device 1008 can automatically forward the signal packet 1020 to the physical board 1016 for automatic execution/adjustment. After all, the board control(s) 1022 can already be formatted and appropriately wrapped so that the host device 1008 does not have to do additional processing before transmitting the board control(s) 1022 to the physical board 1016 for execution. Although the host device 1008 may receive updates to the physical board 1016, it simply forwards the signal packet 1020 having those updates. This configuration in which the cloud server 904 creates direct messages for execution at the physical board 1016 can advantageously reduce or otherwise eliminate lag in the communication of signal controls.

Once the board control(s) 1022 in the signal packet 1020 are executed at the physical board 1016, the physical board 1016 may return updated values (e.g., controls, settings, configurations, audio signals) to the host device 1008. The host device 1008 can transmit said values through the cloud application 904 to the software dashboard 1004 of the sound engineer 1002’s device to validate whether the values from the physical board 1016 (e.g., response to the adjustments/controls 1022) match or otherwise align with the updated values provided by the sound engineer 1002’s device. The sound engineer 1002 may also implement one or more additional adjustments and/or controls based on determining whether the physical board 1016 was properly adjusted.

Signals or other values may also be generated by the audio sources 1012 and/or the cameras 1014, as described above. The audio sources 1012 and/or the cameras 1014 can be in network communication with at least the host device 1008 and/or the physical board 1016, and therefore can provide additional or other channels of communication to other components of the system 1000. For example, the host device 1008 can receive the updated values from the physical board 1016. Before transmitting those updated values to the sound engineer 1002’s device via the cloud server 904, the host device 1008 can package the updated values from the physical board 1016 with other signals from the audio sources 1012 and/or the cameras 1014. The packaged signals and values can then be assessed (e.g., automatically by the cloud server 904 and/or by the sound engineer 1002) to validate that the response matches the dashboard values. The signals from the audio sources 1012 and/or the cameras 1014 can also be transmitted to the sound engineer 1002’s device and used by the sound engineer 1002 to determine one or more other remote controls of the physical board 1016 during an event or other sound session.

FIG. 11 is a conceptual diagram of the system 1000 of FIG. 10 illustrating example channels of communication 1102, 1104, 1106, and/or 1108. As shown herein, the engineer software dashboard 1004, the cloud server 904, the host software dashboard 1010, the physical mixing board 1016, the audio sources 1012, and/or the cameras 1014 can communicate with each other (e.g., wired, wireless). Any of these components can transmit the channels of communication 1102, 1104, 1106, and/or 1108 via the network(s) described herein (e.g., the local network 240). The cloud server 904 can, for example, be configured to broadcast one or more of the channels of communication 1102, 1104, 1106, and/or 1108 to and from the engineer software dashboard 1004 and the physical mixing board 1016. The channels of communication 1102, 1104, 1106, and/or 1108 can be transmitted through different and/or separate ports. In some implementations, any combination of the channels 1102, 1104, 1106, and/or 1108 can be transmitted through a same port. In some implementations, the audio channels 1102 can be prioritized first. Next, the board commands channel 1106 can be prioritized, then the state change channel 1108 can be prioritized, and then the visual channels 1104 can be prioritized. One or more other prioritization schemas may be used, which can vary based on a particular sound session and/or preferences/criteria.

As a merely illustrative example, in a forward flow of audio and state information, the audio sources 1012 can be configured to transmit the audio channels 1102 of signals to the physical mixing board 1016. The physical mixing board 1016 can be configured to transmit the audio channels 1102 to the host software dashboard 1010, which can be configured to transmit the channels 1102 to the cloud server 904, which can further be configured to transmit the channels 1102 to the engineer software dashboard 1004. The audio channels 1102 can also be transmitted to and from one or more other components in the system 1000. It can be preferred and/or advantageous to have high fidelity, real-time or near real-time audio data. Thus, the disclosed technology can be arranged such that the audio channels 1102 are maintained at a higher level of quality than other channels, such as the visual channels 1104.

Similarly, in the forward flow, the cameras 1014 can be configured to transmit visual channels 1104 of signals to the physical mixing board 1016. The physical mixing board 1016 can be configured to transmit the visual channels 1104 to the host software dashboard 1010, which can be configured to transmit the channels 1104 to the cloud server application 904, which can further be configured to transmit the channels 1104 to the engineer software dashboard 1004. The visual channels 1104 can also be transmitted to and from one or more other components in the system 1000. Sometimes, visual data may be of less relevance during a session, so the visual data can be transmitted as low-quality video, thereby reducing burden of that channel 1104.

In a return flow for control commands, the engineer software dashboard 1004 can be configured to transmit the board controls 1106 to the cloud server 904, which can be configured to transmit the controls 1106 to the host software dashboard 1010, which can be further configured to transmit the controls 1106 to the physical mixing board 1016. The physical mixing board 1016 can execute the controls 1106 to cause a change in audio output (e.g., by the audio sources 1012). In a validation look for state synchronization, the state change 1108 at the physical mixing board 1016 can be transmitted to the host software dashboard 1010. The host software dashboard 1010 can be configured to transmit the state change 1108 to the cloud server 904, which can be further configured to transmit the change 1108 to the engineer software dashboard 1004. As a result, GUIs presented at the engineer software dashboard 1004 can be automatically updated based on live changes at the physical mixing board 1016.

As described herein, the system 1000 provides for bidirectional signal flow. An engineer command can be routed through the cloud server 904 to the host software dashboard 1010 such that the host can execute the command on the physical mixing board 1016. Status updates (e.g., new status changes or information) generated by the physical mixing board 1016 can be reported back to the host software dashboard 1010. In a broadcast synch, the host software dashboard 1010 can broadcast the state change 1108 to all connected devices, such as the engineer software dashboard 1004. Automatic updates can be done to the engineer software dashboard 1004 to show a new or updated state of the physical mixing board 1016.

Real-time state synchronization can occur. For example, all parameters of the physical mixing board 1016 can be synchronized in real-time across all connected devices in the system 1000. Multiple different remote engineers can have access to and view the same live state of the mixing board 1016. The system 1000 can implement conflict resolution techniques in some implementations, such that last-command-winds for simultaneous changes made by different engineers. Latency optimization techniques may also be performed for direct local OSC execution (e.g., 10-50 milliseconds (ms)). As described herein, the system 1000 can also provide for signal processing optimization: the commands 1106 can be processed locally at the venue location, cloud connection with the cloud server 904 may provide session management and routing of channels or other information described herein, the host software dashboard 1010 can be configured to maintain physical mixing board 1016 state information (e.g., state caching, such as caching of a complete state or states of the mixing board 1016 during a session), and/or only changed parameters may be transmitted between and amongst the system 1000 components (e.g., delta updates).

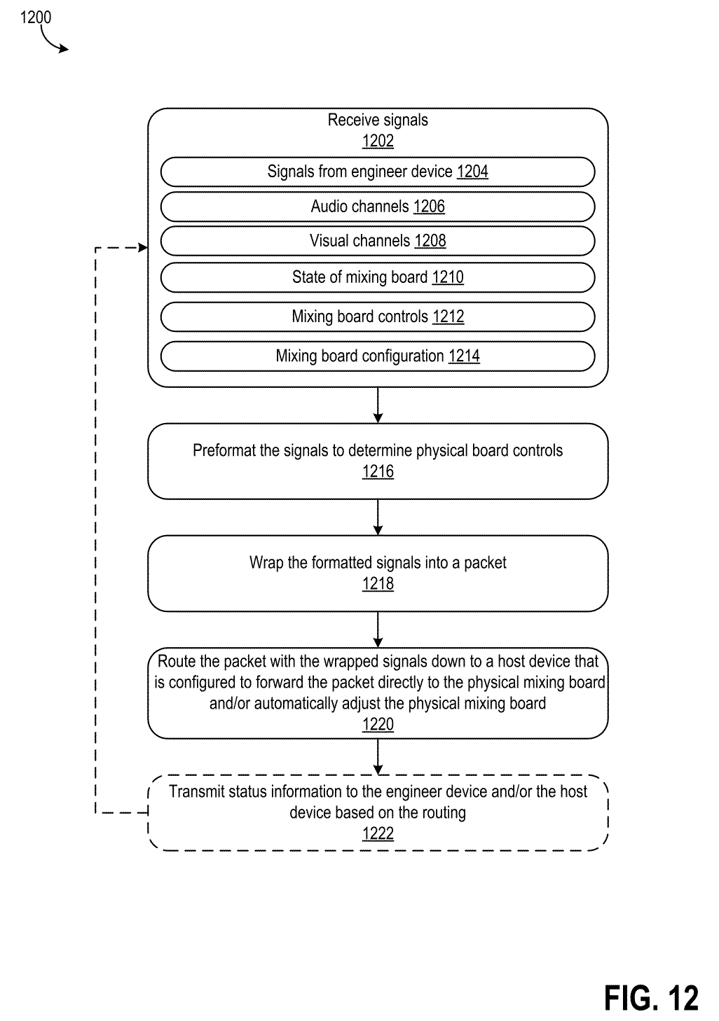

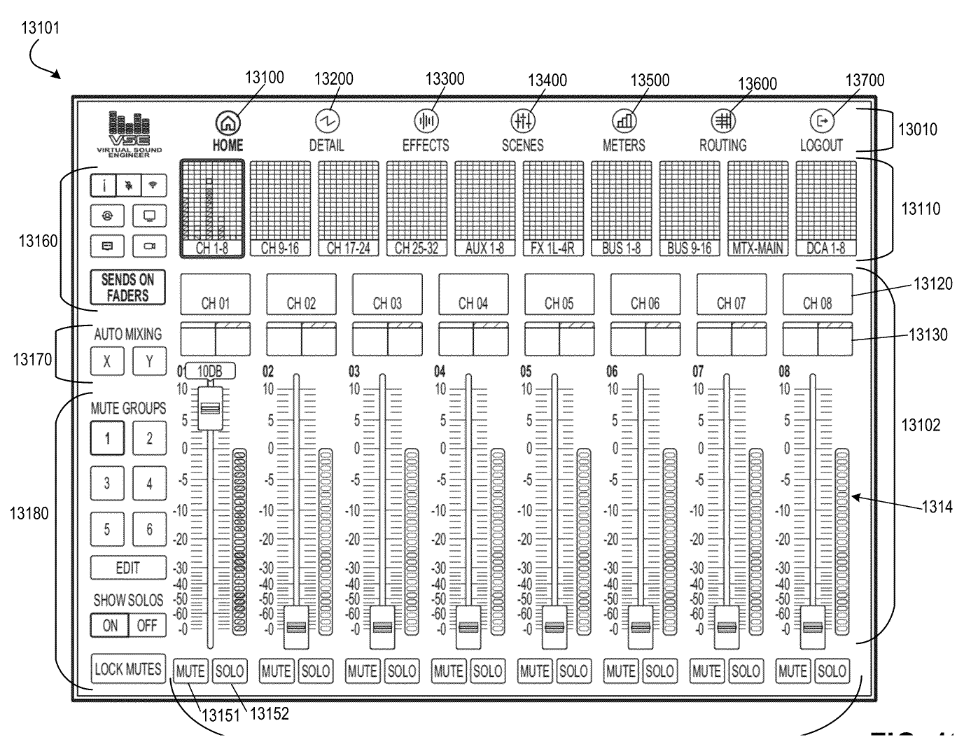

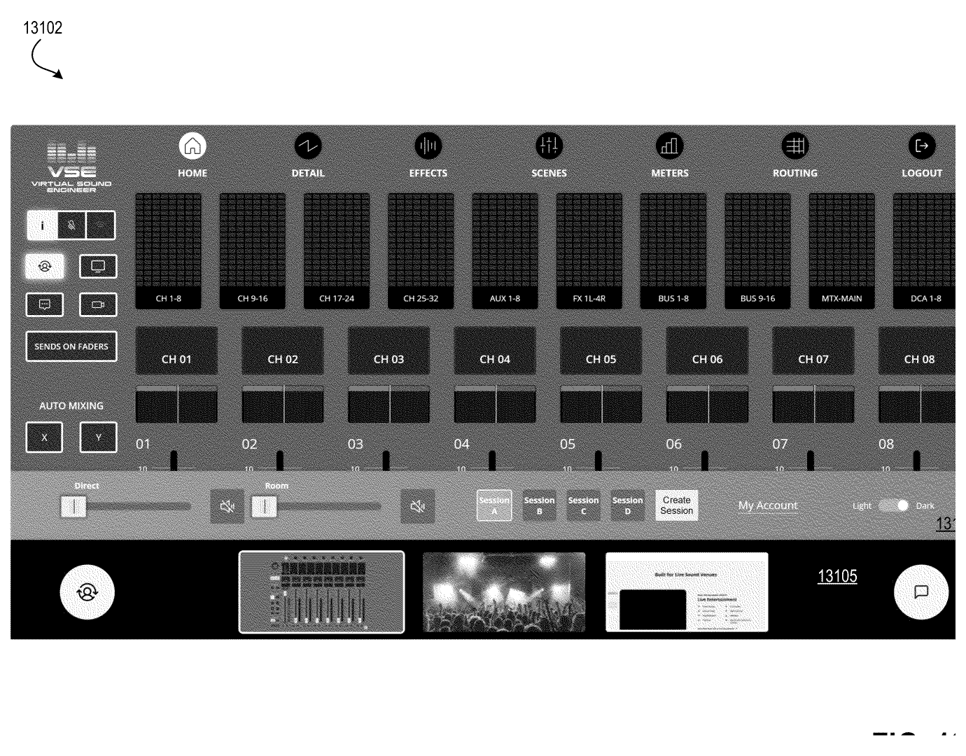

FIG. 12 is a flowchart of a process 1200 for directing controls and other signals to a physical mixing board. The process 1200 can be performed once access to remotely control a sound session is granted, such as described in reference to FIGS. 9A, 9B, and 9C. The process 1200 can be performed by the cloud server 904 described herein. In some implementations, the process 1200 can be performed by one or more other cloud-based systems, computing devices, host devices, sound engineer devices, and/or other systems described herein. For illustrative purposes, the process 1200 is described from the perspective of a cloud server.

The cloud server can receive signals in block 1202. The signals can include signals from a sound engineer’s device (block 1204). The signals can include audio channels (block 1206). The signals can include visual channels (block 1208). The signals can include a current and/or past states of a physical mixing board (block 1210). The signals can include current, past, and/or upcoming mixing board controls (block 1212). The signals can include current, past, and/or upcoming micing board configurations (block 1214). One or more other types of signals described herein and/or combinations thereof can be received in block 1202 by the cloud server.

The cloud server can preformat the signals to determine physical mixing board controls in block 1216. In some implementations, preformatting the signals can include processing the signals from the engineer device (block 1204), which can include updated acoustic values and/or controls that an associated sound engineer desires, with the other signals indicating a current state of the physical mixing board (e.g., the signals in blocks 1206-1214). By processing these signals, the cloud server can determine appropriate controls for the physical mixing board given the state of the physical mixing board and the desired changes/updates by the sound engineer.

As additional examples of preformatting, the cloud server can perform protocol translation to convert high-level control commands into low-level messages that the digital mixing board understands. For example, the cloud server can translate user interface values to normalized parameter ranges, map channel identifiers to hardware-specific address patterns, and/or encode parameter types using appropriate data formats. Preformatting can also include command batching, or grouping multiple related commands into a single packet to reduce network overhead. for example, changing equalization on a channel to generate multiple commands can then be batched together. This significantly reduces round trip latency. Another example of preformatting includes priority scheduling, or analyzing and prioritizing commands based on user impact. The commands can include critical commands (e.g., mute/unmute, fader changes) that may be marked as high priority. The commands can include configuration commands (e.g., scene recalls, routing changes), which may be marked as medium priority. Visual updates (e.g., meter displays) can be marked as low priority and prioritized last relative to the other commands discussed above. Sometimes, the preformatting can include validation and bounds checking, which can include ensuring that all parameter values are within valid threshold ranges for the physical mixing board. For example, the cloud server can clamp parameter values to acceptable ranges, validate frequency ranges and other constraints, and/or reject invalid channel numbers or addresses. Preformatting can sometimes include session context injection, where the cloud server can add metadata to each packet. The metadata can include a session identifier, target mixing board identifier, timestamp(s) for latency measurement(s), and/or sequence number(s) for out-of-order detection(s). In yet some implementations, the preformatting can include integrity verification, in which the cloud server can compute integrity checksums to detect any potential transmission errors. These preprocessing operations can occur rapidly, allowing the formatted signals to be transmitted directly to the mixing board without additional processing at the host device, thereby minimizing control latency.

Once the signals are formatted, the cloud server can wrap the formatted signals into a packet (block 1218). For example, the cloud server can wrap the controls that it determines based on processing the signals in block 1216.

The cloud server can route the back with the wrapped signals down to a host device in block 1220. The host device, as described herein, can be configured to forward the packet directly to the physical mixing board. As a result, the host device may not have to unwrap, translate, and/or format the signals in the packet in order for those signals to be executed at the physical mixing board. Sometimes, as described in reference to at least FIG. 10, the host device can be configured to execute controls to adjust the physical mixing board based on the wrapped signals. As a result, the host device can automatically and directly adjust the physical mixing board in real-time.

Optionally, the cloud server may transmit status information to the engineer device and/or the host device based on the routing (block 1222). The cloud server can generate and transmit status information to the engineer device upon routing the packet to the host device in block 1220. The status information can be generated and transmitted in real-time to provide live synchronization of a state of the physical mixing board to all relevant users, such as the engineer device and the host device. The status information can indicate that the sound engineer’s requested controls/updated values were processed and forwarded to the physical mixing board. In some implementations, the status information can include mixing board state information, including but not limited to a current position of channel faders with corresponding level values, mute/unmute status for each channel, solo states indicating isolated channels, pan positions (e.g., stereo balance), equalization settings for each channel (e.g., multiple bands with frequency, gain, and/or bandwidth parameters), effects routing configuration and parameters, bus send levels and routing matrix, and/or scene recall confirmation (e.g., which present is loaded). The status information can sometimes include execution confirmation information, such as acknowledgements that commands were successfully executed at the physical board, error messages if a command failed (e.g., invalid parameter, board communication timeout), latency measurements (e.g., time from remote click to board execution), and/or sequence numbers confirming command order. Sometimes, the status information can include real-time feedback, such as audio level meters for input channels (e.g., updated multiple times per second), peak indicators showing channels approaching maximum levels, gain reduction meters for dynamic processors, and/or visual feedback matching the physical indicators on the actual mixing board. The status information can include connection health information, which may include network connection status (e.g., connected, reconnecting, disconnected), round-trip latency measurements, packet loss statistics, and/or host relay connection status (e.g., whether the physical board is reachable). Sometimes, the status information can include session participants, such as a list of currently connected users and their roles (e.g., host, remote engineer, observer), user join/leave notifications, and/or indicators of who most recently made a change (e.g., for multi-user collaboration). The status information can also include audio and/or video streams, such as live audio from the location’s sensors or microphones (e.g., compressed using audio codecs), video feeds from the location’s sensors or cameras (e.g., compressed using video codecs), and/or network statistics for media streams (e.g., bitrate, frame rate, buffer health). This comprehensive status information can ensure the remote engineer has full situational awareness equivalent to being physically present at the mixing board, while the host device can monitor all remote control activities for oversight and safety.

The cloud server can generate the status information based on receiving signals or other communications from the physical mixing board and/or other components in a location of the sound session (e.g., audio sources, cameras, the host device). The received signals can indicate changes in controls, states, and/or configurations of the physical mixing board in response to the physical mixing board receiving and processing the signals in the packet. The received signals can indicate changes in sound, acoustics, and/or visuals in response to the physical mixing board receiving and processing the signals in the packet. The cloud server can process the received signals in order to generate the status information and transmit that information to the engineer device and/or the host device. The status information can, for example, be used by a sound engineer at the engineer device to determine whether changes at the physical mixing board and in the sound session correspond to the signals from the engineer device (block 1204) or other controls that are intended for remotely controlling the physical mixing board during the sound session.

Optionally, the cloud server may return to block 1202 and iterate through the blocks of the process 1200 until the sound session ends and/or no more signals are received for the sound session. For example, the process 1200 can be performed continuously during a live sound session and may stop being performed once the live sound session ends. As another example, the process 1200 can be performed before a sound session begins such that a remote sound engineer can preconfigure the physical mixing board for the upcoming sound session. As yet another example, the process 1200 can be performed throughout or during the sound session, such as whenever the remote sound engineer receives signals associated with the sound session and determines that remote adjustments ought to be made.

Referring to the VSE dashboard described and presented herein, FIGS. 13A and 13B illustrate example arrangements of a main page of a VSE dashboard 13101 and 13102, respectively. Referring to both FIGS. 13A and 13B, the main page of the VSE dashboard can include one or more user interface elements including selectable icons, buttons, sliders, and displays. A row of icons 13010, disposed across the top of the dashboard as shown, for example, in FIGS. 13A and 13B, can be used to navigate away from the main dashboard 13101 or 13102 to other pages and dashboard. The row of icon 13010 includes a home icon 13100, a detail icon 13200, an effects icon 13300, a scenes icon 13400, a meters icon 13500, a routing icon 13600, and a logout icon 13700. Interacting with any of the icons takes the user away from the main dashboard to a dashboard associated with the icon.

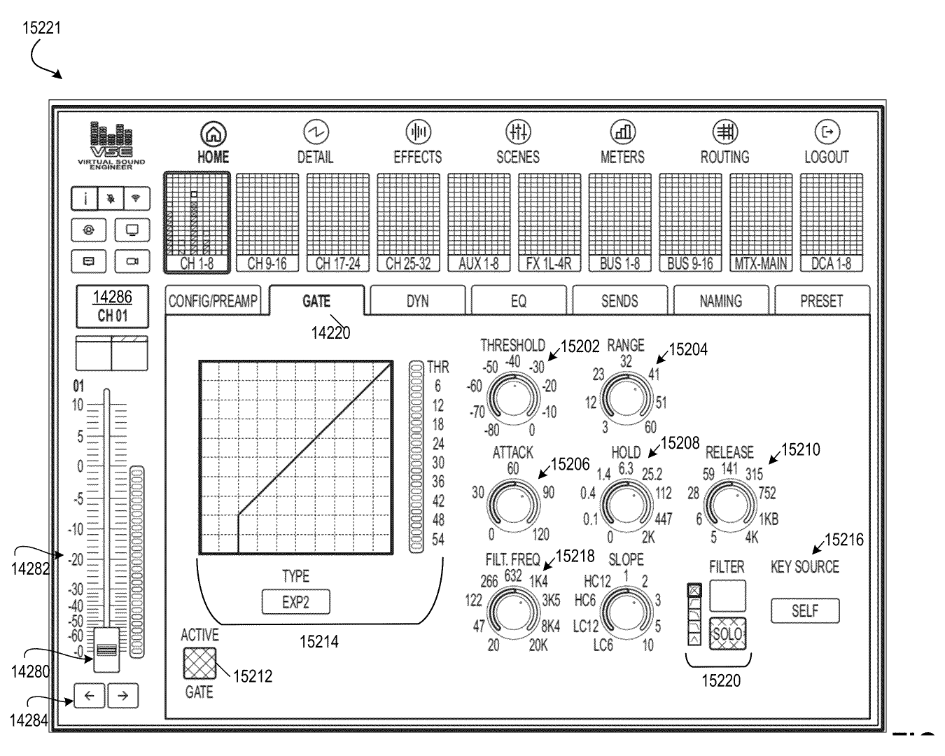

Either of the illustrative examples of the main dashboard 13101 and 13102 further can include a plurality of different groups of user interface elements. The main dashboard includes a plurality of input display windows 13110 that brings up controls and information regarding different inputs when selecting a specific input display window. A summary control window 13102 aggregates information from the different inputs and includes input indicators 13120, channel labels row 13130, and sliders 13140. The input indicators 13120 depicts the name of the input and interacting with the indicator takes the user away from the main dashboard to the details page, as shown in FIG. 14. In other words, the input indicators 13120 can be sends on fader controls that allows the user to switch the dashboard 13102 between a normal channel mixing box and an auxiliary send mixing mode. When activated, the main faders control the send levels to a selected bus rather than the channel output levels, thereby facilitating quick monitor mix adjustments. The channel labels row 13130 provides a display of labels for current channel identifiers corresponding to active channel banks selected from the tables shown above in the dashboard, allowing a user to quickly identify which physical input or bus each fader controls. The sliders 13140 can be fader scale marking, which can show decibel values (e.g., +10, 5, 0, -5, -10, -20, -30, -40) that provide precise visual reference for setting audio levels. The sliders 13140 can therefore enable accurate and repeatable level adjustment across all channels and/or a subset of the channels.

The main dashboard further can include muting controls comprising individual muting controls 13150 and group muting controls 13180. The individual muting controls 13150 includes a mute control 13151 and a solo control 13152 configured to isolate the selected input. The mute control 13151 can be selected to silence the selected channel’s output to the main mix while maintaining the input signal for monitoring and processing. The solo control 13152 can be selected to mute all other channels except the selected one, thereby allowing the remote engineer to isolate and focus on a particular audio source. Multiple channels can also be soloed simultaneously for comparing and/or adjusting related sources (e.g., all drum microphones).

The group muting controls 13180 allows the user to create groups of inputs to mute together or isolate together. The controls 13180 can allow users to create custom groups of channels (e.g., called DCAs, or Digitally Controlled Amplifiers), which can be muted or adjusted together with a single control/input. For example, a drum group may include kick, snare, toms, overhead, and/or room microphones, thereby allowing the remote engineer to mute all drums simultaneously during a live performance. The groups can be created on the fly (e.g., during the live performance), named, color-coded, and/or saved within scenes for instant real-time recall.

The main dashboard further includes an auto mixing control 13170 and a general control panel 13160. The auto mixing controls 13170 can enable the automatic mixing feature that uses digital signal processing to manage multiple open microphones intelligently. The auto-mixer can reduce feedback and ambient noise by automatically lowering the gain of inactive microphones, while also maintaining natural sound when multiple people speak simultaneously. The controls 13170 can include but are not limited to on/off toggle, sensitivity threshold adjustment, attack/release time settings, and/or per-channel enable/disable options for designating which inputs may participate in auto-mixing.

The general control panel 13160 can include one or more selectable icons for performing different actions or operations. Sometimes, the panel 13160 can include global mixing console functions, such as master output level control, main mix mute/unmute, headphone(s) output level, talkback microphone activation, and/or emergency mute-all button. The panel 13160 can sometimes also display a current scene (e.g., preset) name, provide access to scene save/recall functions, and/or show system status indicators such as a power status, sampling parameters, and/or synchronization source(s). As an illustrative example, the general control panel 13160 can include selectable icons for opening and hiding a workstation preview bar 13105 and/or session management bar 13104, as shown in the example VSE dashboard 13102, a mute option, a signal indicator, an option to open and/or hide the session management bar 13104, an option to open a screenshare (which can allow a remote sound engineer to see what is on the client device and/or host screen in case the client/host requires help from the remote engineer with the setup), an option to open a chat feature (which can allow the remote engineer to chat with the client/host during a live session), an option to open/turn on a camera and allow the remote engineer to see the actual venue (e.g., using an external camera that may be connected to the client/host device), an option to view the workstation preview bar 13105 (which can allow the remote engineer to see that the dashboard, camera, and/or screenshare are properly connected), and/or an option to see the session management bar 13104 (which can allow the remote engineer to control a volume of sound from the board and/or from the client/host device). Sometimes, the session management bar option can also be selected to allow the remote engineer to open other sessions with other clients/hosts, switch between live sessions, check their account, and/or perform other functions described herein in the session management bar 13104. The dashboard 13102 can be a main mixing area displaying vertical channel faders with graduated scales for precise level adjustment. Each fader strip can include numeric dB markings ranging from maximum to minimum levels, a moveable fader control, and/or visual level indicators. The dashboard 13102 can also sometimes display eight (8) channels simultaneously and work in conjunction with channel selector tabs to provide access to all mixing console channels.

When selecting one of the plurality of icons 13010, a user is taken to the associated dashboard and away from the main dashboard. The plurality of icons 13010 provide navigation between different groups of channels and buses. Tabs accessibly via the icons 13010 can include input channel banks (CH1-8, CH9-16, CH17-24, CH25-32), auxiliary channels (AUX1-8), effects returns (FX1L-4R), mix buses (BUS1-8, BUS9-16), matrix outputs (MTX-MAIN), and/or digitally controlled amplifiers (DCA1-8). Selecting a tab from amongst the icons 13010 can cause corresponding channels (e.g., 8 channels) to be loaded into the dashboard 13102 (e.g., fader section) for control.

When selecting the detail icon 13200, the user interface is dynamically updated to present a detail dashboard 14201 shown and described in reference to FIG. 14. The detail dashboard 14201 can provide comprehensive controls over a single-selected audio channel (shown as CH 0114286 in this illustrative example). The dashboard 14201 can include a vertical fader 14280 with scale marking 14282 and navigation arrows 14282 for channel selection. The dashboard 14201 can also include a main output fader 14202 with STEREO/MONO/C controls 14211 in addition to selectable options for mute and/or solo 14212, described above.

As shown in the detail dashboard 14201, the user can select and toggle between a configuration/preamp page 14210, a gate page 14220, a dynamics page 14230, an EQ page 14240, a sends page 14250, a naming page 14260, and a preset page 14270 to access corresponding functionality and controls. Selection of any of the pages 14210, 14220, 14230, 14240, 14250, 14260, and/or 14270 can cause the dashboard to be dynamically updated to present corresponding information, user interface elements, and/or controls.

The config/preamp page 14210 allows the user to provide input to adjust an input gain of individual channels before a signal is processed further. This can be crucial for ensuring a clean and balanced audio signal. Key controls can include but are not limited to gain, pad, high-pass filter, and/or phantom power for microphones. The page 14210 also can include functionality for board configuration, and therefore can allow the user to customize and control various aspects of the audio mixing process, including but not limited to input and output routing, EQ settings, effects, and/or overall console layout. It provides a visual interface, such as on a screen, to manage these settings, offering a more detailed and flexible approach compared to analog mixers. Moreover, the page 14210 can display a source selector 14213 (e.g., OFF), link controls 14214, phase inversion button(s)/control(s) 14215, gain controls 14216 (e.g., GAIN, DELAY with rotary encoders showing numeric values 14217A-N), LOW CUT filter 14218, INSERT routing 14219, and/or additional processing options. Sometimes, the page 14210 can also provide options to mute one or more groups 14206, auto mix group controls 14208, and/or apply or adjust weighting parameters 14203. This centralized interface can provide access to major channel processing and routing functions for the selected input.

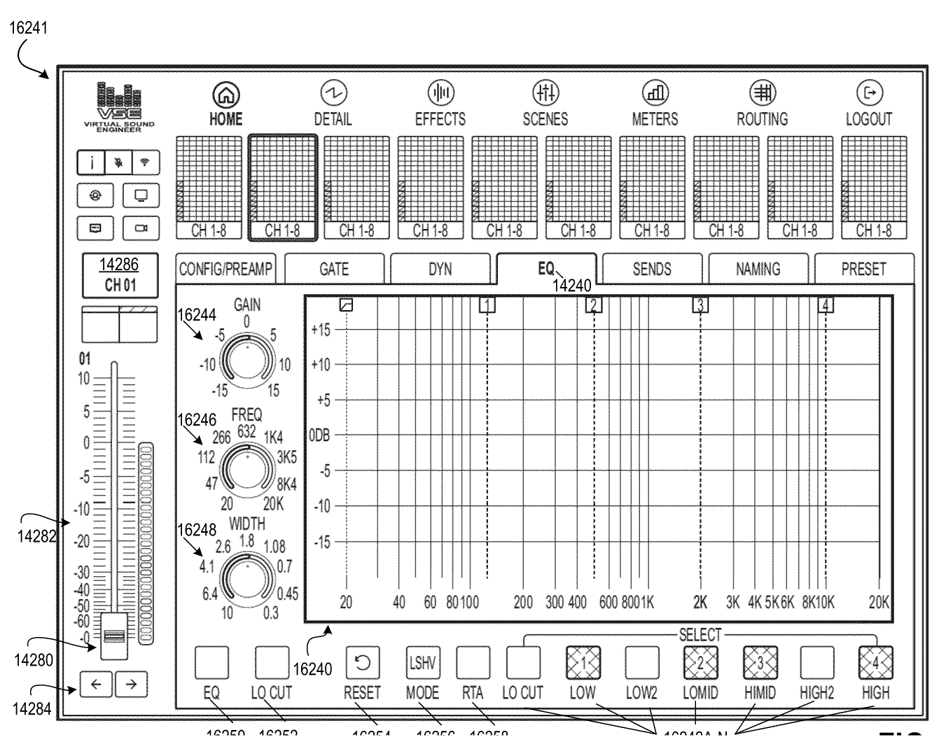

The gate page 14220 provides user-selectable tools to control a dynamic range of audio signals by attenuating those below one or more predetermined thresholds. This functionality can help reduce unwanted noise, feedback, and/or signal bleed, while also allowing for creative shaping of sounds. Example functions include threshold setting, attack, hold, and decay controls, and/or range adjustment. The page 14220 can control a noise gate processor for the selected channel 14286, which automatically mutes the channel when the input signal falls below a predetermined (e.g., user-defined) threshold, effectively eliminating background noise during silence. Sometimes, the controls on the page 14220 can include a threshold slider/dial 15202 (e.g., dB level at which the gate opens), range control 15204 (e.g., amount of gain reduction when the gate closes), attack time 15206 (e.g., how quickly the gate opens when a signal exceeds the predetermined threshold), hold time 15208 (e.g., delay before the gate begins closing), and/or release time 15210 (e.g., speed of gate closure). Visual feedback can also be presented in the page 14220 and can include a real-time gain reduction meter 15212 showing when the gate is active, LED indicators for a gate state (e.g., open, closed, transitioning), and/or an input level meter with threshold overlay 15214. Advanced options may also be presented in the page 14220 and can include external key input selection 15216 (e.g., triggering the gate from a different audio source), sidechain high-pass filter 15218 for frequency-selective triggering, and/or key listen mode 15220 for monitoring the filtered sidechain signal. Refer to FIG. 15 for an illustrative example of a gate page interface 15221.

The Dyn page 14230 or mode provides a dedicated interface for adjusting parameters of dynamics processors. This can include but is not limited to settings for threshold, ratio, attack, release, and makeup gain for a compressor, or other relevant parameters for other dynamics processors.

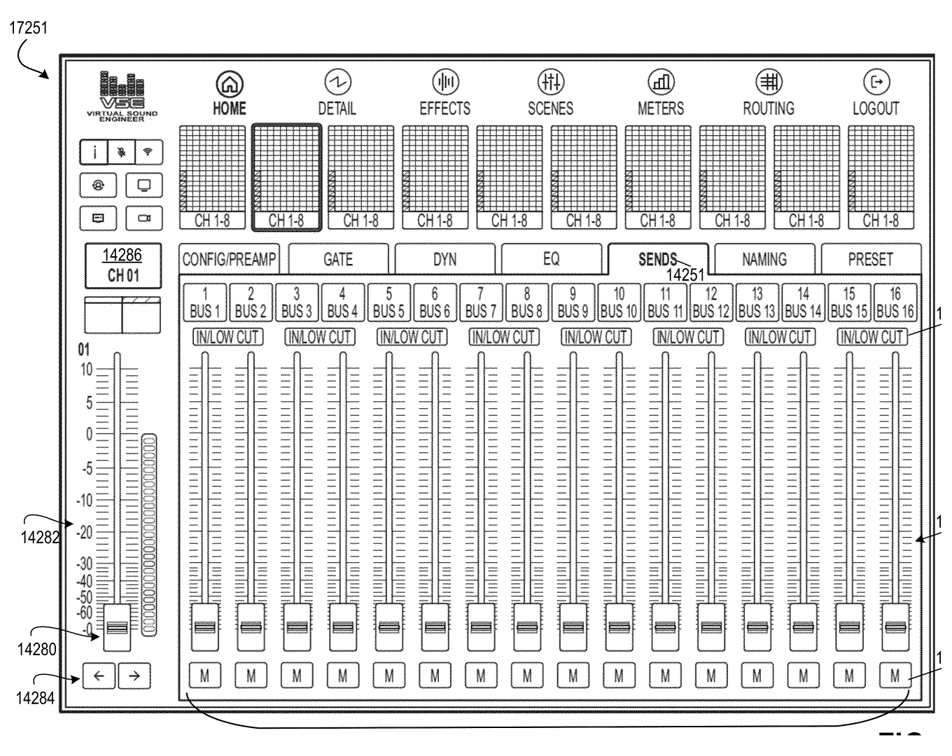

The EQ page 14240 allows the user to adjust the frequency balance of audio signals, shaping overall tonality and removing unwanted frequencies or noise. The EQ section on a digital mixer typically can include parametric controls, allowing for precise adjustments of specific frequencies, bands, and bandwidths, offering more flexibility than analog mixers. More specifically, the page 14240 provides parametric equalization control with one or more (e.g., 4) adjustable frequency bands per channel. The page 14240 can include an interactive frequency response curve graph 16240 (Refer to FIG. 16) that can display a combined effect of all EQ adjustments across the frequency spectrum, such as from 20Hz to 20kHz (e.g., labeled as 20, 40, 60, 80, 100, 200, 300, 400, 600, 800, 1K, 2K, 3K, 4K, 5K, 6K, 8K, 10K, 20K). The page 14240 can also display rotary controls for gain 16244, frequency 16246, and/or bandwidth (Q) 16248 parameters. One or more band selector checkboxes 16242A-N (e.g., 4 checkboxes) can also be presented in the page 14240 to allow for selection of which EQ band to adjust. The curve of the graph 16240 can therefore provide visual feedback showing the frequency response modification(s) in real-time. One or more additional controls can also be included in the page 14240, such as an EQ enable/bypass button 16250, low cut filter 16252, reset 16254, mode 16256, real-time analyzer (RTA) 16258, and/or band select buttons/options 16242A-N (e.g., LO/MID, HI/MID, High, LO/MID, HI/MID, High). This combination of graphical and parametric controls enables precise tonal shaping of each channel. Refer to FIG. 16 for an illustrative example of an EQ page interface 16241.

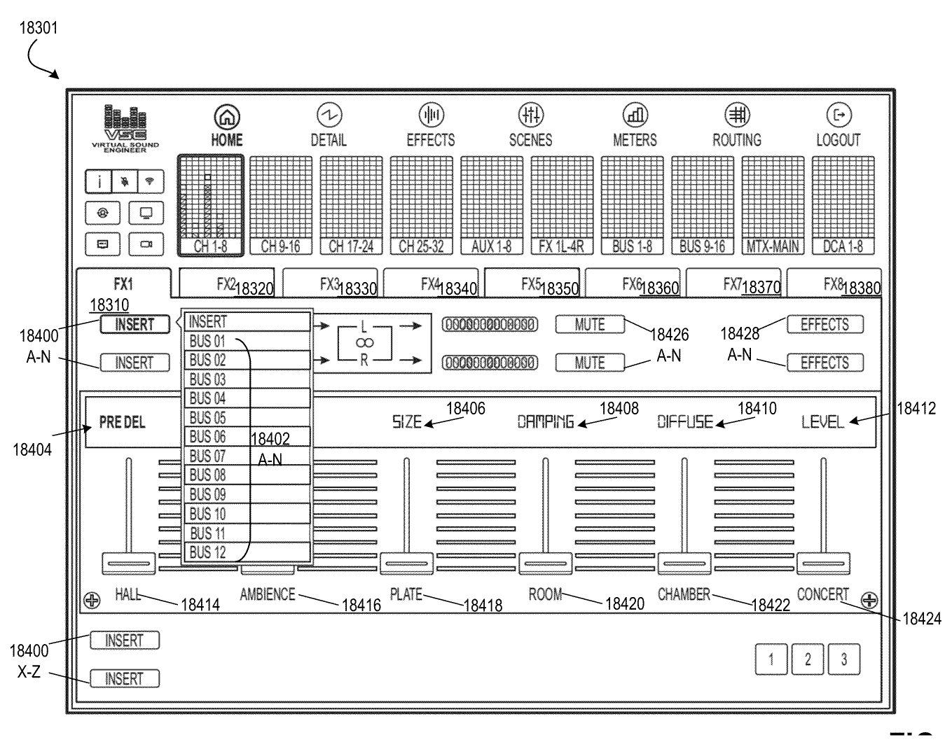

The sender page 14250 can allow the user to control how audio signals are routed from individual channels to auxiliary (aux) sends, which can then be routed to effects processors, monitor mixes, or other destinations. This page can be crucial for creating effects sends, monitor mixes, and other specialized routing scenarios. Accordingly, the page 14251 can manage routing of selected channels to auxiliary buses for monitors, effects, recording feeds, and/or broadcast feeds. The page 14251 can display one or more vertical faders 17250A-N, such as 16 faders labeled BUS 1 through BUS 16, each representing the send level to a corresponding mix bus. Routing selector buttons 17252 may also be associated with and presented with each of the faders, which can be labeled as (IN)/(LOW)/(CUTS) to determine the send’s signal tap point and routing behavior. Each send can include a vertical fader 17254 for level control and/or a mute (M) button 17256 for quickly disabling that send. The consistent layout across all the buses can enable rapid adjustment of multiple sends, making it efficient to create monitor mixes, effects sends, and/or broadcast feeds from the selected channel. This dedicated send view therefore provides simultaneous access to all bus routing from a single source channel. Refer to FIG. 17 for an illustrative example of a sends page interface 17251.

The preset page 14270 can allow the user to save and recall specific settings for channels, mixes, and/or entire console configurations. These presets, often called scenes or snapshots, can be used to quickly load pre-configured settings for different songs, instruments, or even specific performers, streamlining the mixing process and ensuring consistency.

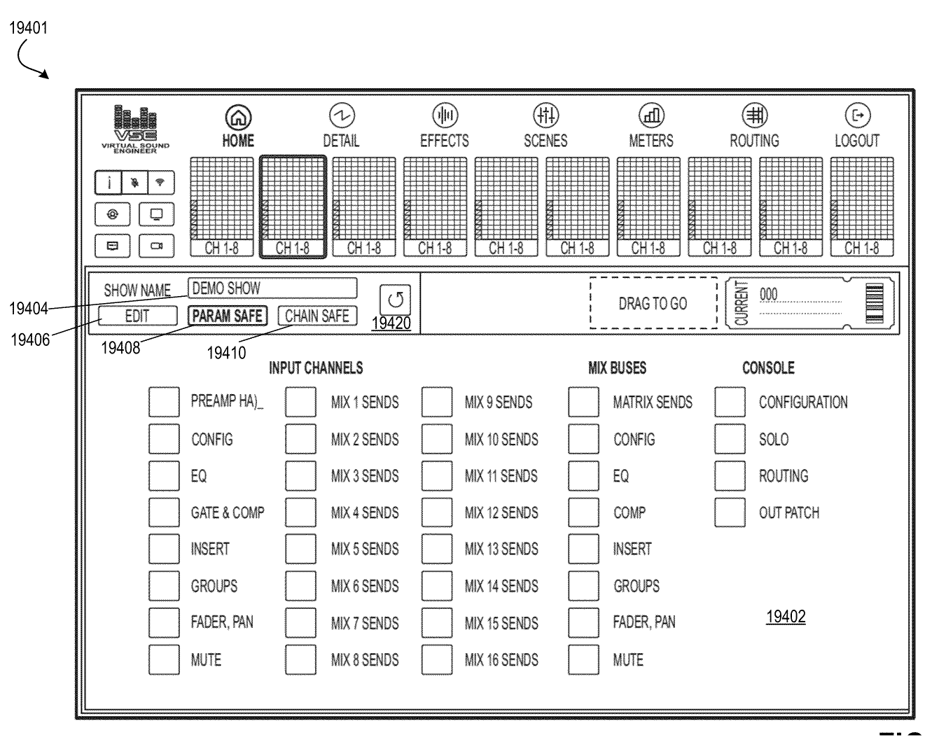

FIG. 18 illustrates an example FX dashboard interface 18301, which provides control over the mixing console’s internal digital effects processors. The interface 18301 can be presented in response to the user selecting the effects option 13300 in FIG. 13A. The interface 18301 provides input fields for the user to apply various audio processing effects to individual channels or an entire mix. These effects can range from basic equalization and compression to more complex processes like reverb, delay, chorus, etc. The effects page can provide controls to adjust effect parameters and routing options to send audio to and from external effects units. The FX dashboard interface 18301 can also provide access to an effects rack, where different effects can be selected and adjusted, as well as aux sends and returns for routing signals to and from external effects units.

The interface 18301 can display effects slot tabs (e.g., 18310, 18320, 18330, 18340, 18350, 18360, 18370, 18380), which can be labeled FX118310 through FXn (e.g., FX8 18380) for selecting which effects processor(s) to edit. A routing section of the interface 18301 can provide selectable insert options 18400A-N and 18400X-Z and bus routing selections 18402A-N (e.g., BUS 01-12) for directing audio to the selected effect processor(s). Sometimes, the interface 18301 can include a pre-delay control slider (PRE/DEL) 18404 and one or more parameter sliders, such as for size 18406, damping 18408, diffuse 18410, and/or level 18412, thereby allowing adjustment of the selected effect’s characteristics. Effect type selection buttons and/or sliders may also be presented in the interface 18301, such as for the following preset categories: hall 18414, ambience 18416, plate 18418, room 18420, chamber 18422, and/or concert 18424 for reverb-based effects. Additional controls may include mute 18426A-N and effects 18428A-N buttons for bypassing or enabling the effects processor. The interface 18301 enables comprehensive control of multiple simultaneous effects processors with flexible routing options.

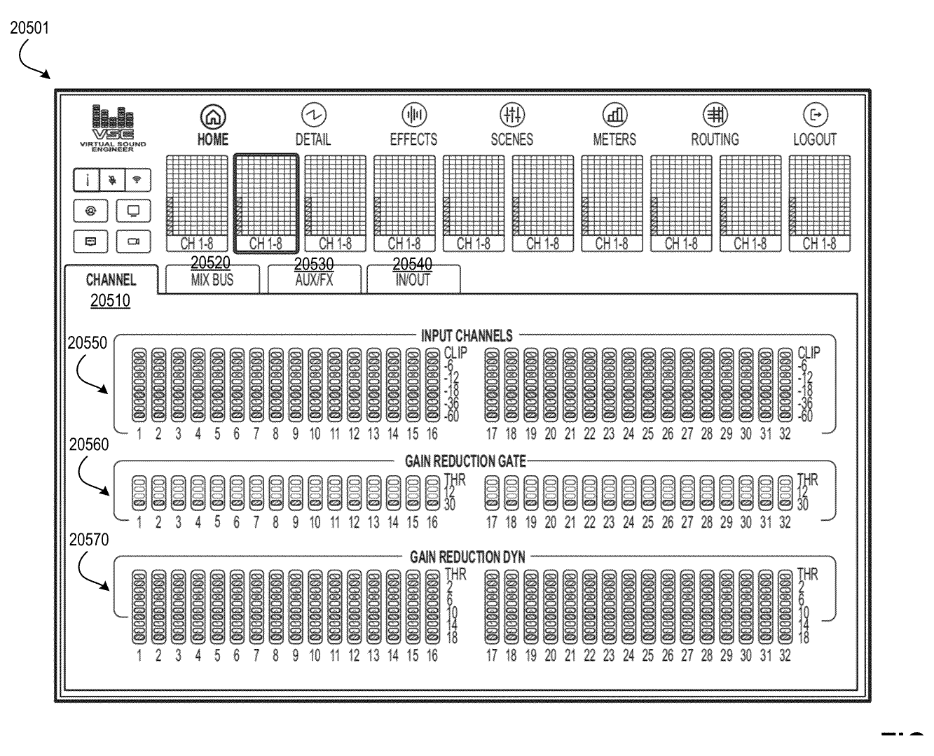

FIG. 19 illustrates an example scenes dashboard interface 19401 for managing snapshots (e.g., scenes) of the entire mixing console configuration for instant recall. The interface 19401 can be presented in response to the user selecting the scenes option 13400 in FIG. 13A. The interface 19401 can provide input fields for the user to save and recall an entire state of the console, or previous states of the console, including but not limited to input levels, EQ settings, effects, and/or routing. This feature can be crucial for live performances and recordings, enabling quick transitions between different song arrangements or specific moments in a show. Scenes streamline workflow, enhance consistency, and provide a valuable tool for training less experienced operators. Moreover, the interface 19401 can display a show name field 19420, demo show selector 19404, and/or control buttons for edit 19406, parameter safe 19408, and/or channel safe 19410. The interface 19401 may contain checkbox matrices 19402 organized into multiple columns such as input channels (e.g., with options for PREAMP HAL, CONFIG, EQ, GATE & COMP, INSERT, GROUPS, FADER, PAN MUTE), mix buses (e.g., with options for MIX 1-16 sends), mix buses continued (e.g., with additional mix send options), and/or console (e.g., with additional options for configuration, solo, routing, out patch). Sometimes, the interface 19401 can be a drag-to-go interface with scene selector and barcode displays that enable quick scene recall. These selectable options (e.g., checkboxes) can allow for selective recall of scene parameters, thereby enabling users to load only specific aspects of a saved configuration.

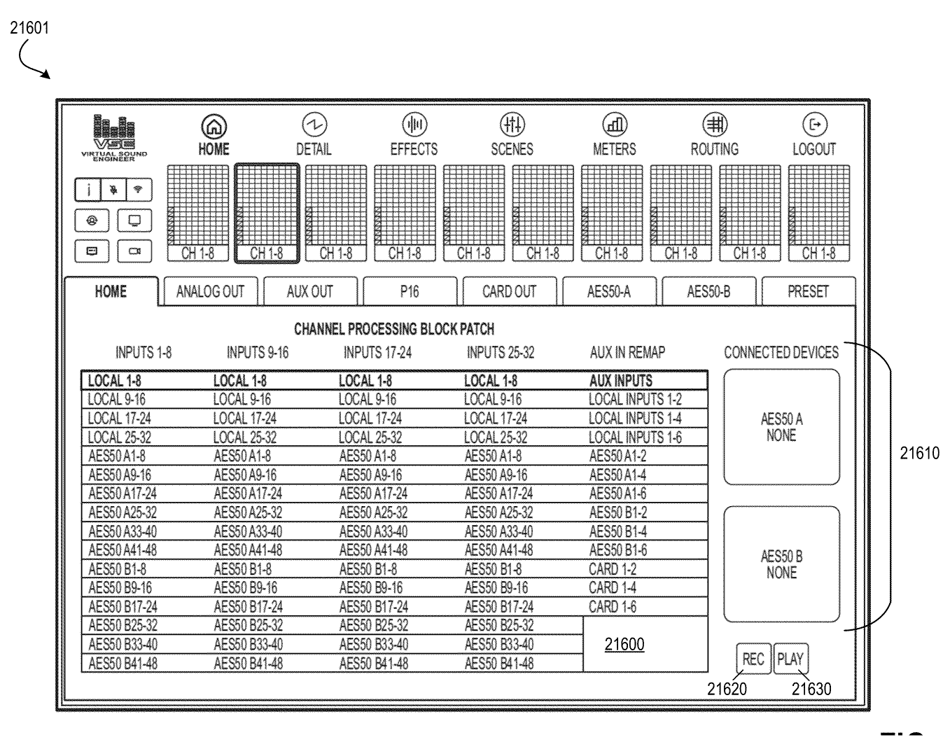

FIG. 20 illustrates an example meters dashboard interface 20501, which provides comprehensive visual feedback of audio signal levels throughout the mixing system. The interface 20501 can be presented in response to the user selecting the meters option 13500 in FIG. 13A. The interface 20501 can provide input fields and display visual representations of audio signal levels at various points in the mixing process. These meters, which can be crucial for monitoring signal strength and identifying potential issues such as clipping, can be found on both input channels and master output and may also be present on individual buses or groups. Sometimes, the interface 20501 can include tab selectors for different metering views, such as CHANNEL 20510, MIX BUS 20520, AUX/FX 20530, and/or IN/OUT 20540. The interface 20501 can display rows of meters for all channels, such as input channels meters 20550 (e.g., a top row showing signal levels for channels 1-32), gain reduction gate meters 20560(e.g., a middle row displaying gate processor activity for the channels 1-32), and/or gain reduction dynamics meters 20570(e.g., a bottom row showing compressor/dynamics processor activity for the channels 1-32). The visual design of the interface 20501 can include graphical meter displays with graduated marking, enabling simultaneous monitoring of input levels and processing activity across all channels. A meter bridge format of the interface 20501 can allow the remote engineers to quickly identify problematic channels and/or verify processing is working correctly across the entire mix.

FIG. 21 illustrates an example routing dashboard 21601 providing a comprehensive pathing interface for channel processing. The interface 21601 can be presented in response to the user selecting the routing option 13600 in FIG. 13A. The interface 21601 can provide input fields for the user to customize how audio signals flow through the console, connecting inputs to channels and outputs. The user can assign sources (such as microphones or instruments) to specific channels on the board and determine where those channels are sent (e.g., to main outputs, monitor mixes, recording devices). This customization can be crucial for tailoring the console’s behavior to different setups and workflows. The interface 21601 can include navigation tabs for HOME, ANALOG OUT, AUX OUT, P16, CARD OUT, AES50-A, AES50-B, and/or PRESET, thereby allowing selection of different routing destinations. The interface 21601 may also display a routing matrix 21600 where rows can represent input sources (e.g., LOCAL 1-8, LOCAL 9-16, LOCAL 17-24, LOCAL 25-32, and/or multiple banks of AES50 digital audio network inputs A1-8 through B41-48) and columns that can represent output routing destinations. A CONNECTED DEVICES section 21610 can also be presented to show available AES50-A and AES50-B network devices. Record 21620 and play 21630 buttons can be presented in the interface 21601 to allow flexible signal routing from any input source to any output destination, including local analog I/O, digital network I/O via AES50 protocol, and/or card-based expansion outputs. Routing configurations shown in the dashboard 21601 can support advanced workflows including stage boxes, recording interfaces, and/or distributed audio systems.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected. The invention is not limited to the specific embodiments disclosed, and may include different combinations of the elements disclosed, omission of some elements or the replacement of elements by the equivalents of such structures.

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

1. A virtual sound engineer system for remote control of a physical mixing board during a sound session, the system comprising:
a cloud server that is configured to establish a remote connection between a remote engineer device and a host device to remotely control the physical mixing board, wherein the cloud server is configured to perform operations comprising:
in response to receipt of a first request, from the host device, to host a digital mixing session for the sound session, initiating the digital mixing session;
receiving a second request to remotely access the digital mixing session from the remote engineer device, wherein the second request comprises session information associated with the digital mixing session;
granting, based on validating the session information, remote access of the remote engineer device to the digital mixing session, wherein in response to granting the remote access, the remote engineer device is configured to present the digital mixing session in a virtual sound engineer dashboard;
receiving, from the remote engineer device and based on the remote access to the digital mixing session, one or more signals for controlling the physical mixing board;
formatting and wrapping the one or more signals for controlling the physical mixing board into a signal packet; and
directing the signal packet to the host device for execution, wherein the host device is configured to automatically adjust the physical mixing board based on the one or more signals in the signal packet.

2. The system of claim 1, wherein the operations further comprise:
receiving, from the host device, updated values that were generated at the physical mixing board in response to the host device automatically adjusting the physical mixing board; and
transmitting the updated values to the remote engineer device for real-time presentation in the virtual sound engineering dashboard.

3. The system of claim 2, wherein the remote engineer device is further configured to receive user input indicating one or more additional controls based on the updated values that are presented in the virtual sound engineering dashboard at the remote engineer device.

4. The system of claim 2, wherein the operations further comprise: processing the updated values to validate that the updated values correspond to the one or more signals for controlling the physical mixing board that were received from the remote engineer device.

5. The system of claim 1, wherein the operations further comprise: receiving (i) audio data by channels from audio sources and (ii) visual data by channels from cameras, wherein the channels from the audio sources and the channels from the cameras are separate and distinct channels of communication.

6. The system of claim 5, wherein the operations further comprise:
transmitting the audio data and the visual data to the remote engineer device for presentation in the virtual sound engineering dashboard; and
receiving, from the remote engineer device, other signals for controlling the physical mixing board based on the audio data and the visual data that are presented in the virtual sound engineering dashboard.

7. The system of claim 1, wherein the host device and the remote engineer device are configured to present the same virtual sound engineering dashboard, and wherein state changes that are detected at the physical mixing board are transmitted, by the cloud server, to the host device and the remote engineer device to cause the virtual sound engineering dashboard to be updated and synchronized in real-time.

8. The system of claim 7, wherein the virtual sound engineering dashboard is presented based on rendering a three-dimensional (3D) representation of the physical mixing board at the host device and the remote engineer device.

9. The system of claim 8, wherein the 3D representation of the physical mixing board comprises a plurality of virtual user controls that correspond to physical controls on the physical mixing board.

10. The system of claim 9, wherein at least one of the remote engineer device or the host device is configured to:
receive user input indicating a change in position of a virtual user control associated with at least one of the physical controls on the physical mixing board; and
transmit the user input to the cloud server for formatting and directing to the physical mixing board for automatic execution.

11. The system of claim 1, wherein the physical mixing board is at a physical location of the sound session.

12. The system of claim 1, wherein the host device is at a physical location of the sound session and the remote engineer device is remote from the physical location of the sound session.

13. The system of claim 11, wherein the remote engineer device is at another physical location that is different than the physical location of the sound session.

14. A virtual sound engineer system for remote control of a physical mixing board during a live sound session at a physical location, the system comprising:
a cloud server that is configured to provide a digital connection between a remote engineer device, a host device, and the physical mixing board, wherein the cloud server is configured to perform operations comprising:
receiving, from the remote engineer device and by a remote access digital mixing session, one or more signals for controlling the physical mixing board;
wrapping the one or more signals for controlling the physical mixing board; and
directing the wrapped signals to the host device by the remote access digital mixing session, wherein the host device is configured to automatically execute the wrapped signals to control the physical mixing board in real-time.

15. The system of claim 14, wherein the operations further comprise (i) initiating a first access digital mixing session between the cloud server and the host device and (ii) directing the wrapped signals to the host device by the first access digital mixing session.

16. The system of claim 15, wherein the operations further comprise (i) initiating a second access digital mixing session between the cloud server and the remote engineer device and (ii) receiving the one or more signals for controlling the physical mixing board from the remote engineer device by the second access digital mixing session.

17. The system of claim 14, wherein the operations further comprise:
receiving, from the host device, updated values that were generated at the physical mixing board in response to the automatic execution of the wrapped signals; and
transmitting the updated values to the remote engineer device for real-time presentation in a virtual sound engineering dashboard.

18. The system of claim 14, wherein the operations further comprise:
receiving, from the physical mixing board, (i) audio data that was generated by audio sources and (ii) visual data that was generated by cameras;
transmitting the audio data and the visual data to the remote engineer device for real-time presentation in a virtual sound engineering dashboard; and
receiving, from the remote engineer device, additional signal commands for controlling the physical mixing board based on the audio data and the visual data that are presented in the virtual sound engineering dashboard.

19. The system of claim 14, wherein the host device and the remote engineer device are configured to present a same virtual sound engineering dashboard.

20. The system of claim 14, wherein the physical mixing board is configured to generate updated state change information in response to the host device automatically executing the wrapped signals to control the physical mixing board, and
wherein the operations further comprise:
receiving the updated state change information from the physical mixing board; and
broadcasting the updated state change information to the host device and the remote engineer device for real-time presentation in one or more graphical user interfaces (GUIs).
